(19) United States
(12) Patent Application Publication
(10) Pub. No.: US 2017/0162896 A1
(43) Pub. Date: Jun. 8, 2017

(54) Layered Electrolytes and Modules for Solid Oxide Cells

(71) Applicant: FCET, Inc., Roswell, GA (US)

(72) Inventors: Mikhail Pozvonkov, Cumming, GA (US); Mark A. Deininger, Roswell, GA (US)

(73) Assignee: FCET, Inc., Roswell, GA (US)

(21) Appl. No.: 15/433,379

(22) Filed: Feb. 15, 2017

Related U.S. Application Data
(63) Continuation of application No. 14/104,994, filed on Dec. 12, 2013.
(60) Provisional application No. 61/736,643, filed on Dec. 13, 2012.

(51) Int. Cl. H01M 8/1253; C25B 9/18; G01N 27/406; C25B 13/04

(52) U.S. Cl. CPC H01M 8/1253; C25B 13/04; C25B 9/18; G01N 27/406; H01M 2008/1293

(57) ABSTRACT

Solid oxide cells having electrolytes comprise alternating layers of metal oxides, in some embodiments. Electrodes in ionic communication with the alternating layers of metal oxides allow for enhanced ionic conductivity. Some embodiments provide for harvesting and releasing ions from the electrolyte using bulk ionic conductivity in combination with interfacial ionic conductivity. Certain embodiments provide for a large number of small cells to reduce material costs without sacrificing cell performance. Techniques for manufacturing, electrode-electrolyte interface materials, and geometries for assembling cells for greater electrical power generation are disclosed.

### CROSS REFERENCE TO RELATED APPLICATIONS

This application is a continuation of and claims benefit of priority under 35 U.S.C. §120 to U.S. Non-Provisional patent application Ser. No. 14/104,994, filed on Dec. 12, 2013, and entitled, “LAYERED ELECTROLYTES AND MODULES FOR SOLID OXIDE CELLS,” which non-provisional patent application claims benefit of priority under 35 U.S.C. §119(e) to U.S. Provisional Patent Application No. 61/736,643, filed on Dec. 13, 2012, and entitled, “LAYERED ELECTROLYTES AND MODULES FOR SOLID OXIDE CELLS,” which non-provisional patent application and provisional patent application are incorporated herein by reference in their entirety.

### FIELD OF INVENTION

This invention relates to electrical energy systems such as fuel cells, electrolyzer cells, and sensors, and, in particular, to solid oxide fuel cells, solid oxide electrolyzer cells, solid oxide sensors, and components of any of the foregoing.

### BACKGROUND OF THE INVENTION

Solid oxide fuel cells, otherwise known as ceramic fuel cells, present an environmentally friendly alternative to mainstream electrical energy production processes involving the combustion of fossil fuels. Solid oxide fuel cells enable the catalytic conversion of chemical energy stored in hydrogen into electrical energy without the concomitant release of greenhouse gases. The generation of electrical current by a solid oxide fuel cell using a hydrogen fuel results in the production of water as opposed to the production carbon dioxide, nitrous oxides, and/or sulfur dioxides associated with the combustion of fossil fuels.

In addition to hydrogen, solid oxide fuel cells are operable to function on a wide variety of fuel sources. Fuel sources in addition to hydrogen include hydrocarbons such as methane, natural gas, and diesel fuel. Hydrocarbon fuel sources are reformed into hydrogen for use with solid oxide fuel cells. Hydrocarbon reforming can be administered prior to entry into the fuel electrode or can be administered at the fuel electrode of a solid oxide fuel cell. The ability to function on a wide variety of fuels distinguishes solid oxide fuel cells from other fuel cells which lack the ability to operate on various fuels. Furthermore, the ability of solid oxide fuel cells to administer hydrocarbon feedstock reformation frees such fuel cells from the limitations associated with hydrogen production and distribution.

Currently, solid oxide fuel cells operate at high temperatures ranging from about 800° C. to 1000° C. As a result of high operating temperatures, solid oxide fuel cells require the use of exotic materials which can withstand such operating temperatures. The need for exotic materials greatly increases the costs of solid oxide fuel cells, making their use in certain applications cost-prohibitive. High operating temperatures exacerbate stresses caused by differences in coefficients of thermal expansion between components of a solid oxide fuel cell. If the operating temperature could be lowered, numerous advantages could be realized. First, less expensive materials and production methods could be employed. Second, the lower operating temperature would allow greater use of the technology. Third, energy needed to heat and operate the fuel cell would be lower, increasing the overall energy efficiency. Fourth, a lower operating temperature increases the service life of the cell. Significantly, the high operating temperature is required because of poor low temperature ion conductivity.

Proton exchange membrane (“PEM”) fuel cells enjoy operational temperatures in the range 50-220° C. Typically relying on special polymer membranes to provide the electrolyte, PEM cells transmit protons across the electrolyte, rather than oxygen ions as in solid oxide fuel cells. However, high proton conductivity requires precise control of hydration in the electrolyte. If the electrolyte becomes too dry, proton conductivity and cell voltage drop. If the electrolyte becomes too wet, the cell becomes flooded. Electro-osmotic drag complicates hydration control: protons migrating across the electrolyte “drag” water molecules along, potentially causing dramatic differences in hydration across the electrolyte that inhibit cell operation. Accordingly, it would be advantageous to obtain the low operating temperatures of the PEM fuel cell without the need to maintain strict control over electrolyte hydration.

In certain circumstances, a solid oxide fuel cell can operate “in reverse” to electrolyze water into hydrogen gas and oxygen gas by inputting electrical energy. In other circumstances, a solid oxide electrolyzer cell can be designed primarily for use as a hydrolyzer, generating hydrogen and oxygen for later use. In still other circumstances, an electrolyzer cell can be used for other purposes, such as extraction of metal from ore and electroplating. In conventional electrolyzers, electrical energy is lost in the electrolysis reaction driving the diffusion of ions through the electrolyte and across the distance between the electrodes. Also, the ability to conduct electrolysis at higher temperatures would improve the efficiency of the electrolysis. However, at higher temperatures, electrolyzers face similar thermal stresses and cracking caused by differences in coefficients of thermal expansion between components of the solid oxide electrolyzer cell. Accordingly, better matching of coefficients of thermal expansion and lower operating temperatures are desired for electrolyzer cells.

A lambda sensor is a device typically placed in the exhaust stream of an internal combustion engine to measure the concentration of oxygen. That measurement allows regulation of the richness or leanness of the fuel/air mixture flowing into the engine. If the fuel/air stream contains too much oxygen, the quantity λ is greater than 1, and the mixture is too lean. If the fuel/air stream contains too little oxygen, then λ<1 and the mixture is too rich. λ equals 1, the ideal situation, when the mixture contains a stoichiometrically equivalent concentration of oxygen and hydrocarbon to allow for complete combustion. A lambda sensor positioned in the exhaust stream detects the amount of oxygen in the combustion products, thereby providing feedback regarding richness or leanness. Lambda sensors and other sensors rely on the diffusion of oxygen anions (O²⁻) and other ions through barrier materials in ways similar to the manner in which oxygen anions diffuse through a solid electrolyte of a solid oxide fuel cell. Moreover, given the high operating temperature of lambda sensors and similar devices, sensors face thermal stresses, cracking, and delamination issues similar to those facing fuel cells and electrolyzers. Accordingly, embodiments of the present invention provide for improved sensor technology by addressing ionic conductivity and mismatching of coefficients of thermal expansion, among other reasons.

It has recently been reported that adjacent atomically flat layers of strontium titanate (STO) with yttria-stabilized zirconia (YSZ) produce an interface that has a dramatically higher ionic conductivity for oxygen anions. J. Garcia-Barriocanal et al., “Colossal Ionic Conductivity at Interfaces of Epitaxial ZrO₂:Y₂O₃/SrTiO₃ Heterostructures,” 321 SCIENCE 676 (2008). Those authors concluded that growing thin epitaxial layers of YSZ on epitaxial STO caused the YSZ to conform under strain to the crystal structure of the STO, thereby creating voids in the YSZ crystal structure at the interface between the two materials. Those voids allowed an increase of oxygen ionic conductivity of approximately eight orders of magnitude relative to bulk YSZ at 500 K (227° C.). However, epitaxially-grown STO and YSZ require an extraordinarily clean environment and a relatively small scale, in addition to expensive deposition equipment. Furthermore, the geometries of establishing ionic communication between an electrode and an interface present another obstacle: the region for harvesting ions at the intersection of three materials (electrode, STO, and YSZ, for example) is by definition small compared to the contact area possible between an electrode and an electrolyte.

In view of the foregoing problems and disadvantages associated with the high operating temperatures of solid oxide cells, it would be desirable to provide solid oxide cells that can demonstrate lower operating temperatures. In addition, providing solid oxide cells and components that better tolerate higher temperatures would be advantageous. Moreover, the efficiency losses due to the thickness of electrolytes make thinner electrolytes desirable. Furthermore, it is also desirable to construct metal oxide electrolytes having dramatically higher ionic conductivities. Large-scale production of metal oxide electrolytes would be facilitated if higher ionic conductivities could be achieved without requiring epitaxial growth of electrolyte materials. It would be advantageous, also, if the geometry of harvesting ions at the intersection of three materials could be addressed.

### SUMMARY OF THE INVENTION

It has been reported by the applicants and colleagues in PCT Application No. PCT/US2011/024242, published on Aug. 18, 2011, as WO 2011/100361, and entitled, “LOW TEMPERATURE ELECTROLYTES FOR SOLID OXIDE CELLS HAVING HIGH IONIC CONDUCTIVITY,” that an electrolyte of a solid oxide cell can be engineered to address some of the problems and shortcomings associated with solid oxide cells. The disclosure of the '242 PCT application is incorporated herein by reference in its entirety. Here, applicants report further unexpected developments of this technology.

Applicants have unexpectedly discovered methods for fabricating metal oxide electrolytes for use in solid oxide cells that do not require painstaking epitaxial growth of electrolyte materials, in some embodiments of the present invention. In other embodiments, unexpectedly high ionic conductivities can be observed. In still other embodiments, unexpectedly high ionic conductivities can be observed at relatively low temperatures. Yet additional embodiments provide the advantageous harvesting or releasing of ions using bulk ionic conductivity across short distances for example on the nanometer scale, and also employ rapid interfacial ionic conductivity across a solid oxide cell on a larger, for example millimeter, scale.

Some embodiments of the present invention provide solid oxide cells, modules of solid oxide cells, and assemblies of such modules that exhibit enhanced performance relative to previous technologies. Enhanced performance may include one or more of increased ionic conductivity, lower temperature, mechanical stability for example at the microscopic level, increased electrical power output per mass or volume, and versatile and adaptable cell design. Applicants have unexpectedly found that a combination of materials, preparation techniques, and cell geometries have yielded surprisingly versatile modules of solid oxide cells that are robust, scalable, and can be harnessed in large numbers for greater power, in some embodiments of the present invention.

Certain embodiments of the present invention take advantage of an unexpectedly successful combination of ionic diffusion through bulk metal oxide electrolyte, with ionic diffusion along an interface between two metal oxide materials. Ionic diffusion through the bulk of a metal oxide having one or more of an acceptable ionic conductivity at a given temperature, thickness, coefficient of thermal expansion, and other properties, allows a larger number of ions to enter and leave an electrolyte compared to the flux of ions entering an interface only. Once in the metal oxide, the ions can reach the interface that exhibits dramatically increased ionic conductivity. This advantageously affords a greater current density, lower operating temperature, smaller cell size, lower cost, greater simplicity of manufacture, or a combination of such advantages, in some embodiments of the present invention.

Certain embodiments of the present invention provide enhanced ionic conductivity through the metal oxide electrolyte, thereby allowing a lower operating temperature. By lowering the operating temperature of a solid oxide cell, less exotic and easier-to-fabricate materials can be utilized in the construction of the cell leading to lower production costs. Thus, some embodiments of the present invention provide solid oxide cells and components thereof employing simpler, less-expensive materials than the current state of the art. For example, if the operating temperature of a solid oxide cell can be lowered, then metals can be used for many different components such as electrodes and interconnects. At these lower operating temperatures, metals have more desirable mechanical properties, such as higher strength, than ceramics. In addition, this higher strength can allow metal components also to have a higher degree of porosity. Current ceramic electrode materials allow for porosity levels in the range of 30% to 40%. Incorporating higher porosity levels in ceramic materials renders them too structurally weak to support cell construction. However, through the use of certain metals or metal carbides, the porosity of an electrode can be provided in the higher range of 40% to 80% and yet retain sufficient mechanical strength for cell construction. Some embodiments of the present invention provide an electrode having a porosity ranging from about 40% to about 80%.

Lower production costs in addition to lower operating temperatures provide the opportunity for solid oxide cells to find application in a wider variety of fields. Additionally, lower operating temperatures reduce degradative processes such as those associated with variances in coefficients of thermal expansion between dissimilar components of the cell. Accordingly, some embodiments provide means and methods for reducing a degradation process in a solid oxide cell.

Still other embodiments produce a desirable surface catalytic effect. For example, by using the process of some embodiments of the present invention, thin films of metal oxides and pure metals (or other metal compounds) can be formed on the exposed pore surfaces of electrodes to produce more chemically active sites at triple phase boundaries where either fuel-gas (as in the case of the anode electrode) or gaseous oxygen (as in the case of the cathode electrode) come into contact with the solid (yet porous) electrodes in a fuel cell.

Other embodiments provide methods of making solid oxide cells and components thereof. Certain embodiments provide methods of making solid oxide cells and components thereof applying temperatures dramatically below those of current methods. Current methods of making solid oxide fuel cells involve the sintering of ceramic and/or metal powders. High sintering temperatures during fabrication of various components, such as the electrolyte, can compound problems associated with variances in coefficients of thermal expansion. For example, high sintering temperatures can also accelerate grain growth, reducing ionic conductivity.

As used herein, “solid oxide cell” means any electrochemical cell that contains a metal oxide electrolyte, and refers to, for example, solid oxide fuel cells, solid oxide electrolyzer cells, cells that can operate as a fuel cell and an electrolyzer cell, and solid oxide sensors.

“Metal oxide electrolyte” indicates a material, useful as an electrolyte in a solid oxide cell, which contains a metal oxide. The metal oxide electrolyte can contain one or more metal oxides dispersed in any suitable manner. For example, two metal oxides can be mixed together in the manner of ZrO₂:Y₂O₃, or SrTiO₃. For another example, two metal oxides can be present in discrete domains having an abrupt interface between them. In yet another example, two metal oxides can form a diffuse interface between them. Still further examples provide more than two metal oxides present in a metal oxide electrolyte, such as, for example, ZrO₂:Y₂O₃/SrTiO₃. The metal oxide electrolyte optionally further contains a material other than a metal oxide. Examples include, but are not limited to, metals, semiconductors, insulators (other than metal oxides), carbides, nitrides, phosphides, sulphides, and polymers, and combinations thereof. In the context of this disclosure, silicone polymers are polymers, while silica is a metal oxide. When used in this document, the meaning of “material” includes metal oxides unless otherwise indicated.

Accordingly, some embodiments of the present invention provide an electrolyte for a solid oxide cell, comprising at least one interface between a strontium titanate material and an yttria-stabilized zirconia material adapted to allow ionic conductivity along the interface.

Additional embodiments relate to an electrolyte for a solid oxide cell, comprising at least one region adapted to allow ionic conductivity through bulk electrolyte material; and at least one interface between two metal oxide materials adapted to allow ionic conductivity along the interface.

Other embodiments involve an electrolyte for a solid oxide cell, comprising a first region proximate to a first electrode adapted to allow ionic conductivity through bulk electrolyte material; a second region proximate to a second electrode adapted to allow ionic conductivity through bulk electrolyte material; and at least one interface between two metal oxide materials adapted to allow ionic conductivity along the interface, wherein the at least one interface separates the first region and the second region, and provides ionic communication between the first region and the second region.

Further embodiments employ an electrolyte for a solid oxide cell, comprising a plurality of interfaces between alternating layers of a first metal oxide material and a second metal oxide material adapted to allow ionic conductivity along the interfaces. In some cases, the first metal oxide material is a strontium titanate material, and the second metal oxide material is an yttria-stabilized zirconia material.

As stated above, solid oxide cells are contemplated. For example, some embodiments relate to a solid oxide cell, comprising an electrolyte comprising a plurality of interfaces between alternating layers of a first metal oxide material and a second metal oxide material adapted to allow ionic conductivity along the interfaces; a first electrode, in ionic communication with the plurality of interfaces of the electrolyte; a second electrode, electrically isolated from the first electrode by the electrolyte, and in ionic communication with the plurality of interfaces of the electrolyte; interposed between the first electrode and the plurality of interfaces of the electrolyte, a first electrode-electrolyte transition element; and interposed between the second electrode and the plurality of interfaces of the electrolyte, a second electrode-electrolyte transition element. In some cases, the first metal oxide material is a strontium titanate material, and the second metal oxide material is an yttria-stabilized zirconia material.

Various substrates are also contemplated. Certain embodiments provide a substrate for a solid oxide cell, wherein the substrate is substantially planar and having a front surface and a back surface, wherein both the front surface and the back surface comprise an electrolyte that comprises a plurality of interfaces between alternating layers of a first metal oxide material and a second metal oxide material, wherein the plurality of interfaces are substantially planar and substantially parallel to the substrate. In certain cases, the first metal oxide material is a strontium titanate material, and the second metal oxide material is an yttria-stabilized zirconia material.

Further embodiments relate to a substrate for a solid oxide cell having at least one substantially planar surface, comprising: an electrolyte that comprises a plurality of interfaces between alternating layers of a strontium titanate material and an yttria-stabilized zirconia material.

Still other embodiments involve a solid oxide cell, comprising multiple substrates, wherein each substrate comprises an electrolyte that comprises a plurality of interfaces between alternating layers of a first metal oxide material and a second metal oxide material adapted to allow ionic conductivity along the interfaces; multiple anodes, wherein at least one anode is in ionic communication with the plurality of interfaces on a given substrate of the multiple substrates; multiple cathodes, wherein at least one cathode is in ionic communication with the plurality of interfaces on a given substrate of the multiple substrates, and wherein the at least one cathode is in ionic communication with the at least one anode via the plurality of interfaces and is electrically isolated from the at least one anode by the electrolyte; multiple support elements, wherein at least one support element is positioned on a given substrate to support and separate the multiple substrates, thereby defining a first conduit over each anode for a fuel fluid and a second conduit over each cathode for an oxygen-containing fluid. In some instances, the first metal oxide material is a strontium titanate material, and the second metal oxide material is an yttria-stabilized zirconia material.

Further embodiments provide a solid oxide cell, comprising multiple substrates, wherein each substrate comprises an electrolyte that comprises a plurality of interfaces between alternating layers of a first metal oxide material and a second metal oxide material adapted to allow ionic conductivity along the interfaces; an anode element in ionic communication with the plurality of interfaces; and a cathode element in ionic communication with the plurality of interfaces, wherein the cathode element is in ionic communication with the anode element via the plurality of interfaces and is electrically isolated from the at least one anode by the electrolyte and the multiple substrates. In additional cases, the first metal oxide material is a strontium titanate material, and the second metal oxide material is an yttria-stabilized zirconia material.

Additional embodiments relate to a solid oxide cell, comprising multiple substrates, wherein each substrate is substantially planar and has a front surface and a back surface, wherein the front surface and the back surface comprise an electrolyte comprising a plurality of interfaces between alternating layers of first metal oxide material and a second metal oxide material, wherein the plurality of interfaces are substantially planar and substantially parallel to the substrate; wherein each substrate contacts at least one other substrate so the multiple substrates form a stair-step stack having a top region and a bottom region; wherein the top region comprises a first electrode in ionic communication with the plurality of interfaces of both the front surface and the back surface of each substrate; wherein the bottom region comprises a second electrode in ionic communication with the plurality of interfaces of both the front surface and the back surface of each substrate, and the first electrode and the second electrode are electrically isolated from each other by the electrolyte and the multiple substrates. In certain additional cases, the first metal oxide material is a strontium titanate material, and the second metal oxide material is an yttria-stabilized zirconia material.

Methods of making an electrolyte also appear in some embodiments of the present invention. For example, certain embodiments relate to a method of making an electrolyte for a solid oxide cell, comprising applying a first metal compound to a substrate; converting at least some of the first metal compound to form a first metal oxide on the substrate; applying a second metal compound to the substrate comprising the first metal oxide; and converting at least some of the second metal compound to form a second metal oxide on the substrate comprising the first metal oxide, thereby forming the electrolyte; wherein the electrolyte has an ionic conductivity greater than the bulk ionic conductivity of the first metal oxide and of the second metal oxide. It is possible that the substrate can be a glass substrate, in certain instances.

Methods of using appear in various embodiments of the present invention. Fuel cells, electrolyzers, and sensors appear more fully described below.

These and other embodiments are described in greater detail in the description which follows.

### BRIEF DESCRIPTION OF THE DRAWINGS

The figures are not necessarily to scale, and should not be construed as limiting. Some details may be exaggerated to aid comprehension.

FIG. 1 shows one embodiment employing two mechanisms by which oxygen ions diffuse through the electrolyte from the cathode to the anode when the solid oxide cell is operated as a fuel cell.

FIG. 2 shows a further embodiment wherein the electrodes more directly contact the interfaces in the electrolyte. Vertical arrows indicate opportunities for oxygen ions to diffuse through bulk material, and horizontal arrows indicate opportunities for oxygen ions to diffuse along the interfaces.

FIGS. 3-4 show another embodiment in which several solid oxide cells are stacked together and operated as a fuel cell. FIG. 3 is a perspective view of a module (300), and FIG. 4 is a side view of only a portion of module (300). Air is passed through oxidant channels (350) to contact cathodes (310), and hydrogen gas is passed through fuel channels (360) to contact anodes (320).

FIGS. 5-7 show a further embodiment having cells formed on rectangular substrates (430) and stacked into a “cross-shaped” module (400) (see FIG. 7). The image in FIG. 7 is a top view showing two rectangular substrates (430) stacked on top of each other at a 90 degree angle. FIG. 5 shows a greater number of cells stacked on top of each other to form a larger module (400) while looking edge on to a cathode (410) (see View A). FIG. 6 shows the module (400) while looking edge on to an anode (420) (see View B). The view in the callout of FIG. 6 shows the substrates (430) that support and separate the cells, and those substrates (430) can be sealed with ceramic or solder glass powder sealant (416).

FIG. 8 shows yet another embodiment comprising a number of cross-shaped modules arranged into a module assembly (500). Air flow over cathodes (510), hydrogen gas flow over anodes (520), oxygen ion diffusion through electrolyte (545), and current collection points (512, 522) are indicated.

FIG. 9 shows another embodiment wherein underlying layers of yttria-stabilized zirconia (640) are exposed to the cathode (610) and the anode (620). As explained elsewhere, the yttria-stabilized zirconia can be replaced with another metal oxide material having a good ionic conductivity, in some embodiments of the present invention.

FIG. 10 shows an additional embodiment viewed in cross section by Scanning Transmission Electron Microscopy (“STEM”) showing alternating layers of YSZ (720) and STO (740) on glass (750). The identity of the layers was determined by Energy Dispersive X-Ray (“EDX”) Elemental Analysis (not shown).

FIG. 11 shows yet another embodiment viewed in cross section by STEM comprising a layer of yttria-stabilized zirconia (820) over a layer of strontium titanate (840). Magnification is approximately 1.3 million. Scale is shown in FIG. 12 and FIG. 13.

FIG. 12 shows the same embodiment shown in FIG. 11 with EDX signals for strontium (960) and titanium (970) overlaying the STEM image, confirming the identity of the STO layer (940).

FIG. 13 shows the same embodiment shown in FIG. 11 and FIG. 12 with EDX signals for yttrium (1065) and zirconium (1075) overlaying the STEM image, confirming the identity of the YSZ layer (1020).

FIGS. 14-15 show the open circuit voltage (FIG. 14) and the current (FIG. 15) generated by a cell having a layer of YSZ over a layer of STO, plotted versus temperature.

### DETAILED DESCRIPTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

The present invention provides solid oxide cells, components thereof, and methods of making and using the same.

### The Substrate

The substrate for a cell can be any suitable substrate.

Certain embodiments provide a substrate in the form of a thin sheet. In some of those embodiments, the substrate comprises at least one thin sheet. Thin sheets of material, such as, for example, glass, mica, metal oxides, conductors, semiconductors, and insulators, can be used. Some embodiments employ thin sheets of SiO₂, MgO, BaTiO₃, NaCl, KCl, alone or in combination. Also, thin sheets are chosen from crystalline material such as slices of single crystal and epitaxial films grown on a substrate and optionally removed from that substrate. Other materials that can be used provide a thin sheet that can withstand the temperatures of processing and operation, such as high temperature polymers, for example polyamides. Fused silica glass, soda-lime glass, sodium borosilicate glass, among others, may also be used as a substrate.

Mica appears as flakes, chunks, thin sheets, or a combination thereof, in certain embodiments of the present invention. “Mica,” as used in the present disclosure, refers to a family of readily-cleavable materials, synthetic or naturally-occurring, also known as phyllosilicates. Biotite, muscovite, phlogopite, lepidolite, margarite, and glauconite, and combinations thereof, are types of mica that can be used.

A substrate, in some embodiments, is pretreated prior to application of the metal compound composition. In one embodiment, for example, the substrate can be etched according to known methods, for example, with an acid wash comprising nitric acid, sulphuric acid, hydrochloric acid, phosphoric acid, or a combination thereof, or with a base wash comprising sodium hydroxide or potassium hydroxide, for example. In another embodiment, the substrate is polished, with or without the aid of one or more chemical etching agents, abrasives, and polishing agents, to make the surface either rougher or smoother. In a further embodiment, the substrate is pretreated such as by carburizing, nitriding, plating, or anodizing.

### The Metal Compound Compositions

Some embodiments of the present invention provide metal compound compositions for forming electrolyte.

Applying one or more metal compounds to one or more materials can occur according to any suitable method. Dipping, spraying, brushing, mixing, spin coating, and combinations thereof, among other methods, can be used. Then the metal compound is converted to form at least one metal oxide in the presence of the material, and optionally in the presence of a substrate. In certain embodiments, the metal compound is fully converted to a metal oxide. A metal compound composition comprises a metal-containing compound that can be at least partially converted to a metal oxide. In some embodiments, the metal compound composition comprises a metal carboxylate, a metal alkoxide, a metal β-diketonate, or a combination thereof.

A metal carboxylate comprises the metal salt of a carboxylic acid, e.g., a metal atom and a carboxylate moiety. In some embodiments of the present invention, a metal salt of a carboxylic acid comprises a transition metal salt. In other embodiments, a metal salt of a carboxylic acid comprises a rare earth metal salt. In a further embodiment, metal carboxylate compositions comprise a plurality of metal salts of carboxylic acids. In one embodiment, a plurality of metal salts comprises a rare earth metal salt of a carboxylic acid and a transition metal salt of a carboxylic acid.

Metal carboxylates can be produced by a variety of methods known to one skilled in the art. Non-limiting examples of methods for producing the metal carboxylate are shown in the following reaction schemes:

nRCOOH+Me→(RCOO)ₙMeⁿ⁺+0.5nH₂ (for alkaline earth metals, alkali metals, and thallium)

nRCOOH+Meⁿ⁺(OH)ₙ→(RCOO)ₙMeⁿ⁺+nH₂O (for practically all metals having a solid hydroxide)

nRCOOH+Meⁿ⁺(CO₃)_{0.5n}→(RCOO)ₙMeⁿ⁺+0.5nH₂O+0.5nCO₂ (for alkaline earth metals, alkali metals and thallium)

nRCOOH+Meⁿ⁺(X)_{n/m}→(RCOO)ₙMeⁿ⁺+n/mHₘX (liquid extraction, usable for practically all metals having solid salts)

In the foregoing reaction schemes, X is an anion having a negative charge m, such as, e.g., halide anion, sulfate anion, carbonate anion, phosphate anion, among others; n is a positive integer; and Me represents a metal atom. R in the foregoing reaction schemes can be chosen from a wide variety of radicals.

Suitable carboxylic acids for use in making metal carboxylates include, for example:

### Monocarboxylic Acids:

Monocarboxylic acids where R is hydrogen or unbranched hydrocarbon radical, such as, for example, HCOOH-formic, CH₃COOH-acetic, CH₃CH₂COOH-propionic, CH₃CH₂CH₂COOH(C₄H₈O₂)-butyric, C₅H₁₀O₂-valeric, C₆H₁₂O₂-caproic, C₇H₁₄-enanthic; further: caprylic, pelargonic, undecanoic, dodecanoic, tridecylic, myristic, pentadecylic, palmitic, margaric, stearic, and nonadecylic acids;

Monocarboxylic acids where R is a branched hydrocarbon radical, such as, for example, (CH₃)₂CHCOOH-isobutyric, (CH₃)₂CHCH₂COOH-3-methylbutanoic, (CH₃)₃CCOOH-trimethylacetic, including VERSATIC 10 (trade name) which is a mixture of synthetic, saturated carboxylic acid isomers, derived from a highly-branched C₁₀ structure;

Monocarboxylic acids in which R is a branched or unbranched hydrocarbon radical containing one or more double bonds, such as, for example, CH₂═CHCOOH-acrylic, CH₃CH═CHCOOH-crotonic, CH₃(CH₂)₇CH═CH(CH₂)₇COOH-oleic, CH₃CH═CHCH═CHCOOH-hexa-2,4-dienoic, (CH₃)₂C═CHCH₂CH₂C(CH₃)═CHCOOH-3,7-dimethylocta-2,6-dienoic, CH₃(CH₂)₄CH═CHCH₂CH═CH(CH₂)₇COOH-linoleic, further: angelic, tiglic, and elaidic acids;

Monocarboxylic acids in which R is a branched or unbranched hydrocarbon radical containing one or more triple bonds, such as, for example, CH≡CCOOH-propiolic, CH₃C≡CCOOH-tetrolic, CH₃(CH₂)₄C≡CCOOH-oct-2-ynoic, and stearolic acids;

Monocarboxylic acids in which R is a branched or unbranched hydrocarbon radical containing one or more double bonds and one or more triple bonds;

Monocarboxylic acids in which R is a branched or unbranched hydrocarbon radical containing one or more double bonds and one or more triple bonds and one or more aryl groups;

Monohydroxymonocarboxylic acids in which R is a branched or unbranched hydrocarbon radical that contains one hydroxyl substituent, such as, for example, HOCH₂COOH-glycolic, CH₃CHOHCOOH-lactic, C₆H₅CHOHCOOH-amygdalic, and 2-hydroxybutyric acids;

Dihydroxymonocarboxylic acids in which R is a branched or unbranched hydrocarbon radical that contains two hydroxyl substituents, such as, for example, (HO)₂CHCOOH-2,2-dihydroxyacetic acid;

Dioxycarboxylic acids, in which R is a branched or unbranched hydrocarbon radical that contains two oxygen atoms each bonded to two adjacent carbon atoms, such as, for example, C₆H₃(OH)₂COOH-dihydroxy benzoic, C₆H₂(CH₃)(OH)₂COOH-orsellinic; further: caffeic, and piperic acids;

Aldehyde-carboxylic acids in which R is a branched or unbranched hydrocarbon radical that contains one aldehyde group, such as, for example, CHOCOOH-glyoxalic acid;

Keto-carboxylic acids in which R is a branched or unbranched hydrocarbon radical that contains one ketone group, such as, for example, CH₃COCOOH-pyruvic, CH₃COCH₂COOH-acetoacetic, and CH₃COCH₂CH₂COOH-levulinic acids;

Monoaromatic carboxylic acids, in which R is a branched or unbranched hydrocarbon radical that contains one aryl substituent, such as, for example, C₆H₅COOH-benzoic, C₆H₅CH₂COOH-phenylacetic, C₆H₅CH(CH₃)COOH-2-phenylpropanoic, C₆H₅CH═CHCOOH-3-phenylacrylic, and C₆H₅C≡CCOOH-3-phenyl-propiolic acids;

### Multicarboxylic Acids:

Saturated dicarboxylic acids, in which R is a branched or unbranched saturated hydrocarbon radical that contains one carboxylic acid group, such as, for example, HOOC—COOH-oxalic, HOOC—CH₂—COOH-malonic, HOOC—(CH₂)₂—COOH-succinic, HOOC—(CH₂)₃—COOH-glutaric, HOOC—(CH₂)₄—COOH-adipic; further: pimelic, suberic, azelaic, and sebacic acids;

Unsaturated dicarboxylic acids, in which R is a branched or unbranched hydrocarbon radical that contains one carboxylic acid group and a carbon-carbon multiple bond, such as, for example, HOOC—CH═CH—COOH-fumaric; further: maleic, citraconic, mesaconic, and itaconic acids;

Polybasic aromatic carboxylic acids, in which R is a branched or unbranched hydrocarbon radical that contains a aryl group and a carboxylic acid group, such as, for example, C₆H₄(COOH)₂-phthalic (isophthalic, terephthalic), and C₆H₃(COOH)₃-benzyl-tri-carboxylic acids;

Polybasic saturated carboxylic acids, in which R is a branched or unbranched hydrocarbon radical that contains a carboxylic acid group, such as, for example, ethylene diamine N,N′-diacetic acid, and ethylene diamine tetraacetic acid (EDTA);

### Polybasic Oxyacids:

Polybasic oxyacids, in which R is a branched or unbranched hydrocarbon radical containing a hydroxyl substituent and a carboxylic acid group, such as, for example, HOOC—CHOH—COOH-tartronic, HOOC—CHOH—CH₂—COOH-malic, HOOC—C(OH)═CH—COOH-oxaloacetic, HOOC—CHOH—CHOH—COOH-tartaric, and HOOC—CH₂—C(OH)COOH—CH₂COOH-citric acids.

A metal compound composition, in some embodiments of the present invention, comprises a solution of carboxylic acid salts of one or more metals (“metal carboxylate”). A liquid metal carboxylate composition can comprise a single metal, to form a single metal carboxylate, or a mixture of metals, to form a corresponding mixture of metal carboxylates. In addition, a liquid metal carboxylate composition can contain different carboxylate moieties. In some embodiments, a liquid metal carboxylate composition contains a mixture of metals, as these compositions form mixed oxides having various properties.

Solvent used in the production of liquid metal carboxylate compositions, in some embodiments, comprise an excess of the liquid carboxylic acid which was used to form the metal carboxylate salt. In other embodiments, a solvent comprises another carboxylic acid, or a solution of a carboxylic acid in another solvent, including, but not limited to, organic solvents such as benzene, toluene, chloroform, dichloromethane, or combinations thereof.

Carboxylic acids suitable for use generating liquid metal carboxylate compositions, in some embodiments, are those which: (1) can form a metal carboxylate, where the metal carboxylate is soluble in excess acid or another solvent; and (2) can be vaporized in a temperature range that overlaps with the oxide conversion temperature range.

In some embodiments, a carboxylic acid has a formula R—COOH, where R is alkyl, alkenyl, alkynyl or aryl.

In some embodiments, the monocarboxylic acid comprises one or more carboxylic acids having the formula I below:

R^{o}—C(R″)(R′)—COOH (I)

wherein:
R^{o} is selected from H or C₁ to C₂₄ alkyl groups; and
R′ and R″ are each independently selected from H and C₁ to C₂₄ alkyl groups; wherein the alkyl groups of R^{o}, R′, and R″ are optionally and independently substituted with one or more substituents, which are alike or different, chosen from hydroxy, alkoxy, amino, and aryl radicals, and halogen atoms.

The term alkyl, as used herein, refers to a saturated straight, branched, or cyclic hydrocarbon, or a combination thereof, including C₁ to C₂₄, methyl, ethyl, n-propyl, isopropyl, n-butyl, isobutyl, t-butyl, n-pentyl, cyclopentyl, isopentyl, neopentyl, n-hexyl, isohexyl, cyclohexyl, 3-methylpentyl, 2,2-dimethylbutyl, 2,3-dimethylbutyl, heptyl, octyl, nonyl, and decyl.

The term alkoxy, as used herein, refers to a saturated straight, branched, or cyclic hydrocarbon, or a combination thereof, including C₁ to C₂₄, methyl, ethyl, n-propyl, isopropyl, n-butyl, isobutyl, t-butyl, n-pentyl, cyclopentyl, isopentyl, neopentyl, n-hexyl, isohexyl, cyclohexyl, 3-methylpentyl, 2,2-dimethylbutyl, 2,3-dimethylbutyl, heptyl, octyl, nonyl, and decyl, in which the hydrocarbon contains a single-bonded oxygen atom that can bond to or is bonded to another atom or molecule.

The terms alkenyl and alkynyl, as used herein, refer to a straight, branched, or cyclic hydrocarbon, including C₁ to C₂₄, with a double or triple bond, respectively.

Alkyl, alkenyl, alkoxy, and alkynyl radicals are unsubstituted or substituted with one or more alike or different substituents independently chosen from halogen atoms, hydroxy, alkoxy, amino, aryl, and heteroaryl radicals.

Moreover, the term aryl or aromatic, as used herein, refers to a monocyclic or bicyclic hydrocarbon ring molecule having conjugated double bonds about the ring. In some embodiments, the ring molecule has 5- to 12-members, but is not limited thereto. The ring may be unsubstituted or substituted having one or more alike or different independently-chosen substituents, wherein the substituents are chosen from alkyl, alkenyl, alkynyl, alkoxy, hydroxyl, and amino radicals, and halogen atoms. Aryl includes, for example, unsubstituted or substituted phenyl and unsubstituted or substituted naphthyl.

The term heteroaryl as used herein refers to a monocyclic or bicyclic aromatic hydrocarbon ring molecule having a heteroatom chosen from O, N, P, and S as a member of the ring, and the ring is unsubstituted or substituted with one or more alike or different substituents independently chosen from alkyl, alkenyl, alkynyl, hydroxyl, alkoxy, amino, alkylamino, dialkylamino, thiol, alkylthio, ═O, ═NH, ═PH, ═S, and halogen atoms. In some embodiments, the ring molecule has 5- to 12-members, but is not limited thereto.

The alpha branched carboxylic acids, in some embodiments, have an average molecular weight ranging from about 130 to 420 g/mol or from about 220 to 270 g/mol. The carboxylic acid may also be a mixture of tertiary and quaternary carboxylic acids of Formula I. VIK acids can be used as well. See U.S. Pat. No. 5,952,769, at col. 6, II. 12-51, which patent is incorporated herein by reference in its entirety.

In some embodiments, one or more metal carboxylates can be synthesized by contacting at least one metal halide with at least one carboxylic acid in the substantial absence of water. In other embodiments, the contacting occurs in the substantial absence of a carboxylic anhydride, yet in specific embodiments at least one carboxylic anhydride is present. In still other embodiments, the contacting occurs in the substantial absence of a catalyst; however, particular embodiments provide at least one catalyst. For example, silicon tetrachloride, aluminum trichloride, titanium tetrachloride, titanium tetrabromide, or a combination of two or more thereof can be mixed into 2-ethylhexanoic acid, glacial acetic acid, or another carboxylic acid or a combination thereof in the substantial absence of water with stirring to produce the corresponding metal carboxylate or combination thereof. Carboxylic anhydrides and/or catalysts can be excluded, or are optionally present. In some embodiments, the carboxylic acid is present in excess. In other embodiments, the carboxylic acid is present in a stoichiometric ratio to the at least one metal halide. Certain embodiments provide the at least one carboxylic acid in a stoichiometric ratio with the at least one metal halide of about 1:1, about 2:1, about 3:1, or about 4:1. The contacting of the at least one metal halide with at least one carboxylic acid can occur under any suitable conditions. For example, the contacting optionally can be accompanied by heating, partial vacuum, and the like.

Either a single carboxylic acid or a mixture of carboxylic acids can be used to form the liquid metal carboxylate. In some embodiments, a mixture of carboxylic acids contains 2-ethylhexanoic acid wherein R^{o} is H, R″ is C₂H₅ and R′ is C₄H₉, in the formula (I) above. The use of a mixture of carboxylates can provide several advantages. In one aspect, the mixture has a broader evaporation temperature range, making it more likely that the evaporation temperature of the acid mixture will overlap the metal carboxylate decomposition temperature, allowing the formation of a metal oxide coating. Moreover, the possibility of using a mixture of carboxylates avoids the need and expense of purifying an individual carboxylic acid.

Other metal compounds can be used to form metal oxides in accordance with the present invention. Such metal compounds can be used alone or in combination, or in combination with one or more metal carboxylates. Metal compounds other than carboxylates and those mentioned elsewhere include metal alkoxides and metal β-diketonates.

Metal alkoxides suitable for use in the present invention include a metal atom and at least one alkoxide radical —OR² bonded to the metal atom. Such metal alkoxides include those of formula II:

M(OR²)_{z} (II)

in which M is a metal atom of valence z+;
z is a positive integer, such as, for example, 1, 2, 3, 4, 5, 6, 7, and 8;
R² can be alike or different and are independently chosen from unsubstituted and substituted alkyl, unsubstituted and substituted alkenyl, unsubstituted and substituted alkynyl, unsubstituted and substituted heteroaryl, and unsubstituted and substituted aryl radicals,
wherein substituted alkyl, alkenyl, alkynyl, heteroaryl, and aryl radicals are substituted with one or more alike or different substituents independently chosen from halogen, hydroxy, alkoxy, amino, heteroaryl, and aryl radicals.
In some embodiments, z is chosen from 2, 3, and 4.

Metal alkoxides are available from Alfa-Aesar and Gelest, Inc., of Morrisville, Pa. Lanthanoid alkoxides such as those of Ce, Nd, Eu, Dy, and Er are sold by Kojundo Chemical Co., Saitama, Japan, as well as alkoxides of Al, Zr, and Hf, among others. See, e.g., http://www.kojundo.co.jp/English/Guide/material/lanthagen.html.

Examples of metal alkoxides useful in embodiments of the present invention include methoxides, ethoxides, propoxides, isopropoxides, and butoxides and isomers thereof. The alkoxide substituents on a given metal atom are the same or different. Thus, for example, metal dimethoxide diethoxide, metal methoxide diisopropoxide t-butoxide, and similar metal alkoxides can be used. Suitable alkoxide substituents also may be chosen from:

1. Aliphatic series alcohols from methyl to dodecyl including branched and isostructured.
2. Aromatic series alcohols: benzyl alcohol-C₆H₅CH₂OH; phenyl-ethyl alcohol-C₈H₁₀O; phenyl-propyl alcohol-C₉H₁₂O, and so on.

Metal alkoxides useful in the present invention can be made according to many suitable methods. One method includes converting the metal halide to the metal alkoxide in the presence of the alcohol and its corresponding base. For example:

MX_{z}+zHOR²→M(OR²)z+zHX

in which M, R², and z are as defined above for formula II, and X is a halide anion.

Metal β-diketonates suitable for use in the present invention contain a metal atom and a β-diketone of formula III as a ligand:

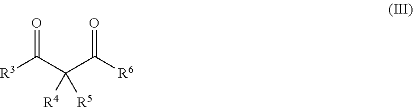

in which
R³, R⁴, R⁵, and R⁶ are alike or different, and are independently chosen from hydrogen, unsubstituted and substituted alkyl, unsubstituted and substituted alkoxy, unsubstituted and substituted alkenyl, unsubstituted and substituted alkynyl, unsubstituted and substituted heteroaryl, unsubstituted and substituted aryl, carboxylic acid groups, ester groups having unsubstituted and substituted alkyl, and combinations thereof,
wherein substituted alkyl, alkoxy, alkenyl, alkynyl, heteroaryl, and aryl radicals are substituted with one or more alike or different substituents independently chosen from halogen atoms, hydroxy, alkoxy, amino, heteroaryl, and aryl radicals.

It is understood that the β-diketone of formula III may assume different isomeric and electronic configurations before and while chelated to the metal atom. For example, the free β-diketone may exhibit enolate isomerism. Also, the β-diketone may not retain strict carbon-oxygen double bonds when the molecule is bound to the metal atom.

Examples of β-diketones useful in embodiments of the present invention include acetylacetone, trifluoroacetylacetone, hexafluoroacetylacetone, 2,2,6,6-tetramethyl-3,5-heptanedione, 6,6,7,7,8,8,8-heptafluoro-2,2-dimethyl-3,5-octanedione, ethyl acetoacetate, 2-methoxyethyl acetoacetate, benzoyltrifluoroacetone, pivaloyltrifluoroacetone, benzoyl-pyruvic acid, and methyl-2,4-dioxo-4-phenylbutanoate.

Other ligands are possible on the metal β-diketonates useful in the present invention, such as, for example, alkoxides such as —OR² as defined above, and dienyl radicals such as, for example, 1,5-cyclooctadiene and norbornadiene.

Metal β-diketonates useful in the present invention can be made according to any suitable method. β-diketones are well known as chelating agents for metals, facilitating synthesis of the diketonate from readily available metal salts.

Metal β-diketonates are available from Alfa-Aesar and Gelest, Inc. Also, Strem Chemicals, Inc. of Newburyport, Mass., sells a wide variety of metal β-diketonates on the internet at http://www.strem.com/code/template.ghc?direct=cvdindex.

In some embodiments, a metal compound composition contains one metal compound as its major component and one or more additional metal compounds which may function as stabilizing additives. Stabilizing additives, in some embodiments, comprise trivalent metal compounds. Trivalent metal compounds include, but are not limited to, chromium, iron, manganese and nickel carboxylates. A metal compound composition, in some embodiments, comprises both cerium and chromium carboxylates.

In some embodiments, the amount of metal forming the major component of the metal compound composition ranges from about 65 weight percent to about 97 weight percent or from about 80 weight percent to about 87 weight percent of the total metal in the compound composition. In other embodiments, the amount of metal forming the major component of the metal compound composition ranges from about 90 weight percent to about 97 weight percent of the total metal present in the compound composition. In a further embodiment, the amount of metal forming the major component of the metal compound composition is less than about 65 weight percent or greater than about 97 weight percent of the total metal present in the compound composition.

In some embodiments, metal compounds operable to function as stabilizing additives are present in amounts such that the total amount of the metal in metal compounds which are the stabilizing additives is at least 3% by weight of the total metal in the liquid metal compound composition.

The amount of metal in a liquid metal compound composition, according to some embodiments, ranges from about 2 to about 150 grams of metal per kilogram of liquid metal compound composition. In other embodiments, the amount of metal in a liquid metal compound composition ranges from about 5 to about 50 grams of metal per kilogram of liquid metal compound composition. In a further embodiment, a liquid metal compound composition comprises from about 10 to about 40 grams of metal per kg of composition. In one embodiment, a metal amount is less than about 2 grams of metal per kilogram of liquid metal compound or greater than 150 grams of metal per kilogram of liquid metal compound.

Liquid metal compound compositions, in some embodiments of solid oxide cell production methods, further comprise one or more catalytic materials. Catalytic materials, in such embodiments, comprise transition metals including, but not limited to, platinum, palladium, rhodium, nickel, cerium, gold, silver, zinc, lead, ruthenium, rhenium, or mixtures thereof. Catalytic materials, in some embodiments, are present in liquid metal compound compositions in an amount ranging from about 0.5 weight percent to about 10 weight percent of the composition. In further embodiments, one or more catalytic materials are present in an amount of less than about 0.5 weight percent of the composition. In still further embodiments, one or more catalytic materials are present in an amount of greater than about 10 weight percent of the composition. In certain embodiments, the catalytic material is present in the liquid metal compound composition in the form of a metal compound. In certain other embodiments, the catalytic material is present in the form of a metal.

In other embodiments, a liquid metal compound composition further comprises nanoparticles operable to alter the pore structure and porosity of the metal oxide resulting from the conversion of the liquid metal compound composition. Nanoparticles, in some embodiments, comprise metal oxide nanoparticles. Nanoparticles, in some embodiments, are present in liquid metal compound compositions in an amount ranging from about 0.5 percent by volume to about 30 percent by volume of the liquid metal compound composition. In another embodiment, nanoparticles are present in the liquid metal compound composition in an amount ranging from about 5 percent by volume to about 15 percent by volume of the liquid metal compound composition.

In addition to liquids, metal compound compositions, in some embodiments of the present invention, comprise solid metal compound compositions, vapor metal compound compositions, or combinations thereof. In one embodiment, a solid metal compound composition comprises one or more metal compound powders. In another embodiment, a vapor metal compound composition comprises a gas phase metal compound operable to condense on a substrate prior to conversion to a metal oxide. In some embodiments, the substrate is cooled to enhance condensation of the vapor phase metal compound composition. In one embodiment, for example, a substrate such as a glass substrate is placed in a vacuum chamber, and the chamber is evacuated. Vapor of one or more metal compounds, such as cerium (IV) 2-hexanoate, enters the vacuum chamber and deposits on the steel substrate. Subsequent to deposition, the metal compound is exposed to conditions operable to convert the metal compound to a metal oxide. In a further embodiment, a metal compound composition comprises gels chosen from suitable gels including, but not limited to, sol-gels, hydrogels, and combinations thereof.

Applying a metal compound composition to a substrate can be accomplished by any suitable method, such as those known to one of skill in the art. In one embodiment, the substrate is dipped into the liquid metal compound composition. In another embodiment, a swab, sponge, dropper, pipette, spray, brush or other applicator is used to apply the liquid metal compound composition to the substrate. In some embodiments, a vapor phase metal compound composition is condensed on the substrate. In other embodiments, lithographic methods can be used to apply the metal compound composition to the substrate.

A metal compound composition, in some embodiments, is applied to the substrate at a temperature less than about 250° C. In other embodiments, a metal compound composition is applied to the substrate at a temperature less than about 200° C., less than about 150° C., less than about 100° C., or less than about 50° C. In a further embodiment, a metal compound composition is applied to the substrate at room temperature. An additional embodiment provides a metal compound composition applied at less than about room temperature.

Following application, the metal compound composition is at least partially converted to a metal oxide. In some embodiments, the metal compound composition is fully converted to a metal oxide.

Converting a metal compound composition comprising a metal salt of a carboxylic acid, according to some embodiments of the present invention, comprises exposing the metal compound composition to an environment operable to convert the metal salt to a metal oxide. Environments operable to convert metal compounds to metal oxides, in some embodiments, provide conditions sufficient to vaporize and/or decompose the compound moieties and precipitate metal oxide formation. In one embodiment, an environment operable to convert metal compounds to metal oxides comprises a heated environment. A metal salt of a carboxylic acid, for example, can be exposed to an environment heated to a temperature operable to convert the carboxylic acid and induce formation of the metal oxide. In some embodiments, the environment is heated to a temperature greater than about 200° C. In other embodiments, the environment is heated to a temperature greater than about 400° C. In certain embodiments, the environment is heated to a temperature up to about 425° C. or up to about 450° C. In additional embodiments, the environment is heated to a temperature ranging from about 400° C. to about 650° C. In a further embodiment, the environment is heated to a temperature ranging from about 400° C. to about 550° C.

The rate at which the environment is heated to effect the conversion of the at least one metal compound to the at least one metal oxide is not limited. In some embodiments, the heating rate is less than about 7° C./minute. In other embodiments, the heating rate is equal to about 7° C./minute. In still other embodiments, the heating rate is greater than about 7° C./minute. The heating rate, according to certain iterations of the present invention, is equal to the heating rate of the oven in which the conversion takes place. Particular embodiments provide a heating rate that is as fast as the conditions and equipment allow.

In some embodiments, the metal oxide penetrates into the substrate to a depth ranging from about 0.5 nm to about 100 nm or from about 20 nm to about 80 nm. In other embodiments, the metal oxide penetrates into the substrate to a depth ranging from about 30 nm to about 60 nm or from about 40 nm to about 50 nm. Converting the metal compound on the substrate to a metal oxide, in some embodiments, produces a transition layer comprising metal oxide and substrate material, in some embodiments. In other embodiments, the metal oxide does not penetrate into the substrate and an abrupt interface exists between the metal oxide and the substrate.

Moreover, exposing metal compound compositions to environments operable to convert the compositions to metal oxides, as provided herein, eliminates or reduces the need for sintering to produce metal oxides. By eliminating sintering, solid oxide cell production methods of the present invention gain several advantages. One advantage is that the lower temperatures of some methods of the present invention do not induce grain growth or other degradative processes in various components of the solid oxide cell during production. Another advantage is that the compound compositions permit tailoring of individual metal oxide layers in the construction of electrolytes and electrodes. Methods of the present invention, for example, permit one metal oxide layer of an electrolyte or electrode to have completely different compositional and/or physical parameters in comparison to an adjacent metal oxide layer, in some embodiments. Such control over the construction of electrolytes and electrodes of solid oxide cells is extremely difficult and, in many cases, not possible with present sintering techniques. In other embodiments, for example, one material can be prepared with conventional techniques such as sintering or epitaxial growth, while a metal oxide can be formed on that material without the need for sintering.

The conversion environment, for various embodiments of the present invention, can be any suitable environment, and the conversion can be precipitated by any suitable means. In some embodiments of the present invention, the substrate is heated; in others, the atmosphere about the metal compound composition is heated; in still others, the metal compound composition is heated. In further embodiments, a substrate having a metal compound composition deposited thereon can be heated in an oven, or exposed to heated gas. The conversion environment may also be created using induction heating through means familiar to those skilled in the art of induction heating. Alternatively, the conversion environment may be provided using a laser applied to the surface area for sufficient time to allow at least some of the metal compounds to convert to metal oxides. In other applications, the conversion environment may be created using an infra-red light source which can reach sufficient temperatures to convert at least some of the metal compounds to metal oxides. Some embodiments may employ a microwave emission device to cause at least some of the metal compound to convert. Other embodiments provide a plasma to heat the metal compound. In the case of induction heating, microwave heating, lasers, plasmas, and other heating methods that can produce the necessary heat levels in a short time, for example, within seconds, 1 minute, 10 minutes, 20 minutes, 30 minutes, 40 minutes, or one hour.

### The Electrolyte

As stated above, some embodiments of the present invention provide electrolytes, and methods of making and using the same.

Some embodiments of the present invention include electrolytes and methods for making electrolytes having enhanced ionic conductivity. Ionic conductivity is the rate at which one or more ions move through a substance. Ionic conductivity generally depends upon temperature in most solid electrolytes, and is usually faster at higher temperature. In some cases, poor ionic conductivity at room temperature prevents economical use of certain fuel cell technologies. Accordingly, enhancing ionic conductivity can provide either more efficient solid oxide cell operation at a given temperature, or operation at a lower temperature that is thereby rendered efficient enough to be economically feasible.

Ionic conductivity can relate to any ionic conductivity, such as, for example, the conductivity of monoatomic, diatomic, and multiatomic ions; monovalent, divalent, trivalent, tetravalent, and other multivalent ions; cations; anions; solvated and partially-solvated ions, and combinations thereof. In some embodiments, ionic conductivity concerns the conductivity of O²⁻. In other embodiments, ionic conductivity concerns the conductivity of O²⁻, H⁺, H₃O⁺, —OH⁻, NH₄⁺, Li⁺, Na⁺, K⁺, Mg⁺, Ca⁺, F⁻, Cl⁻, Br⁻, I₃⁻, I⁻, and combinations thereof. Ionic conductivity is often reported in units of 1/(ohms cm) or S/cm, where 1 S=1 A/V. In context of the present invention, ionic conductivity is enhanced if, in reference to a literature or experimental value of bulk ionic conductivity of the most-ionic conductive material in the metal oxide electrolyte, the ionic conductivity has increased by a statistically significant amount. In some embodiments, the ionic conductivity has increased at least one order of magnitude, from about one order of magnitude to about two orders of magnitude, from about two orders of magnitude to about three orders of magnitude, from about three orders of magnitude to about four orders of magnitude, from about four orders of magnitude to about five orders of magnitude, from about five orders of magnitude to about six orders of magnitude, from about six orders of magnitude to about seven orders of magnitude, from about seven orders of magnitude to about eight orders of magnitude, from about eight orders of magnitude to about nine orders of magnitude, from about nine orders of magnitude to about ten orders of magnitude, or greater than about ten orders of magnitude.

Certain embodiments of the present invention relate to methods of enhancing ionic conductivity in a metal oxide electrolyte comprising a first metal oxide material and a second metal oxide material comprising:

applying a first metal compound to a substrate; and
converting at least some of the metal compound to form the first metal oxide material;
applying a second metal compound to the first metal oxide material; and converting at least some of the second metal compound to form the second metal oxide material;
wherein the first metal oxide material and the second metal oxide material have an ionic conductivity greater than the bulk ionic conductivity of the first metal oxide material and of the second metal oxide material.

A metal oxide material, in certain embodiments, can comprise, among other things, crystalline material, nanocrystalline material, and combinations thereof. Crystalline material includes single crystals and material that has been formed epitaxially, such as by atomic layer deposition. Some embodiments of the present invention provide at least one metal oxide chosen from strontium titanate, titania, alumina, zirconia, yttria-stabilized zirconia, alumina-doped yttria-stabilized zirconia, iron-doped zirconia, magnesia, ceria, samarium-doped ceria, gadolinium-doped ceria, and combinations thereof. In other embodiments, the metal oxide is chosen from alumina, titania, zirconia, yttria-stabilized zirconia, alumina-doped yttria-stabilized zirconia, iron-doped zirconia, magnesia, ceria, samarium-doped ceria, gadolinium-doped ceria, and combinations thereof.

In still further embodiments, the metal oxide electrolyte comprises a first metal oxide material comprising strontium titanate, and a second metal oxide material comprising yttria-stabilized zirconia. In other embodiments, the first metal oxide material comprises magnesia, and the second metal oxide material comprises yttria-stabilized zirconia. Additional embodiments have a first metal oxide material comprising titania, and a second metal oxide material comprising yttria-stabilized zirconia. Yet other embodiments provide a first metal oxide material comprising strontium titanate, and a second metal oxide material comprising iron-doped zirconia. Certain embodiments include a first metal oxide material comprising samarium-doped ceria, and a second metal oxide material comprising ceria.

Some additional embodiments provide yttria-stabilized zirconia comprising from about 10 mol % to about 20 mol % yttria, from about 12 mol % to about 18 mol % yttria, or from about 14 mol % to about 16 mol % yttria.

In some embodiments, detection of a given material need not require crystallographic analysis. For example, alumina-doped yttria-stabilized zirconia refers to oxide material comprising aluminum, yttrium, zirconium, and oxygen. Accordingly, detection of constituent elements signifies the indicated material. Elemental detection methods are widely known, and include, but are not limited to, flame emission spectroscopy, flame atomic absorption spectroscopy, electrothermal atomic absorption spectroscopy, inductively coupled plasma spectroscopy, direct-current plasma spectroscopy, atomic fluorescence spectroscopy, and laser-assisted flame ionization spectroscopy.

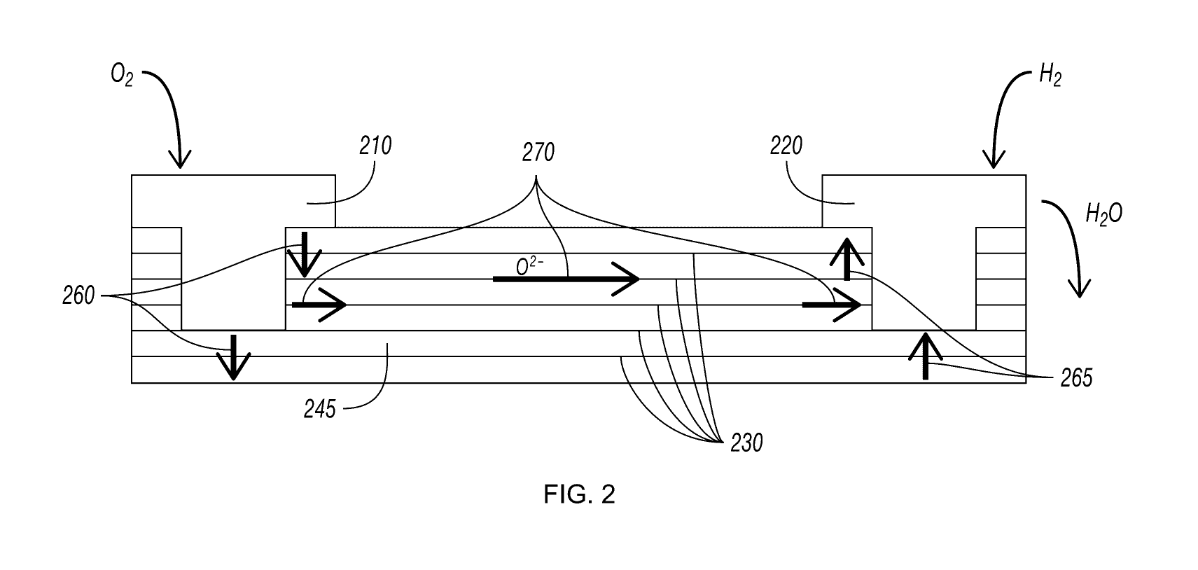

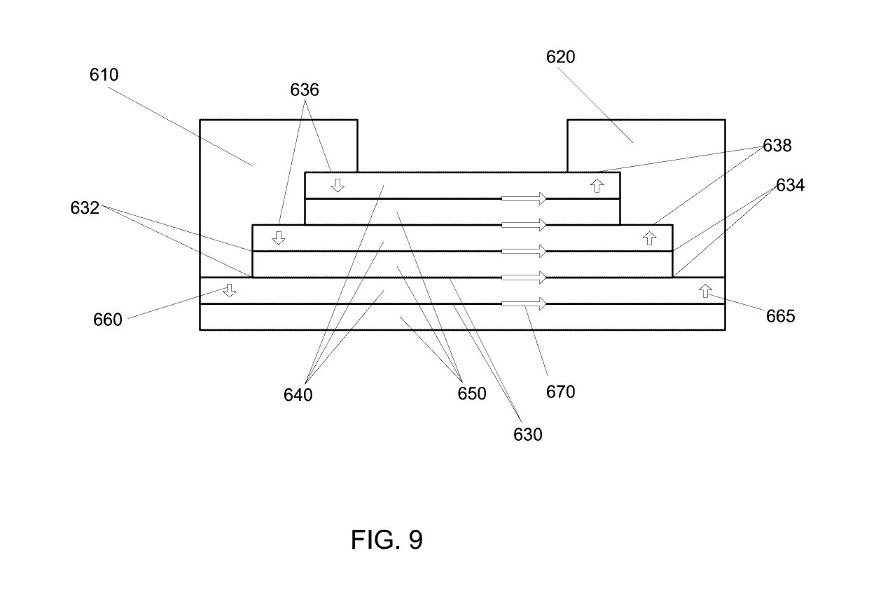

Applicants have found that strontium titanate conducts oxygen ions more slowly than yttria-stabilized zirconia. Accordingly, in some embodiments, the electrolyte is designed to minimize the diffusion or ionic conductivity through bulk strontium titanate or other relatively slow or poor ionic conductor. Therefore, certain embodiments provide an electrode in proximity to yttria-stabilized zirconia to facilitate oxygen ion diffusion into the electrolyte. Other embodiments employ electrodes that integrate with one or more interfaces between the layers of the electrolyte, as shown in FIGS. 2 and 9. Any suitable method allowing electrode-interface contact and ionic communication can be used. For example, the electrolyte can be formed on the substrate, and then the electrolyte can be selectively etched, exposing one or more of the interfaces. Any suitable means for etching can be employed, such as, for example, a diamond scribe, a laser, a molecular ion beam, or a combination thereof can be employed to expose the interfaces. Then, the electrode can be added or formed in the exposure as described herein. Optionally, an electrode-electrolyte transition element is interposed between the exposed interfaces and the electrode, such as by forming the element and then forming the electrode.

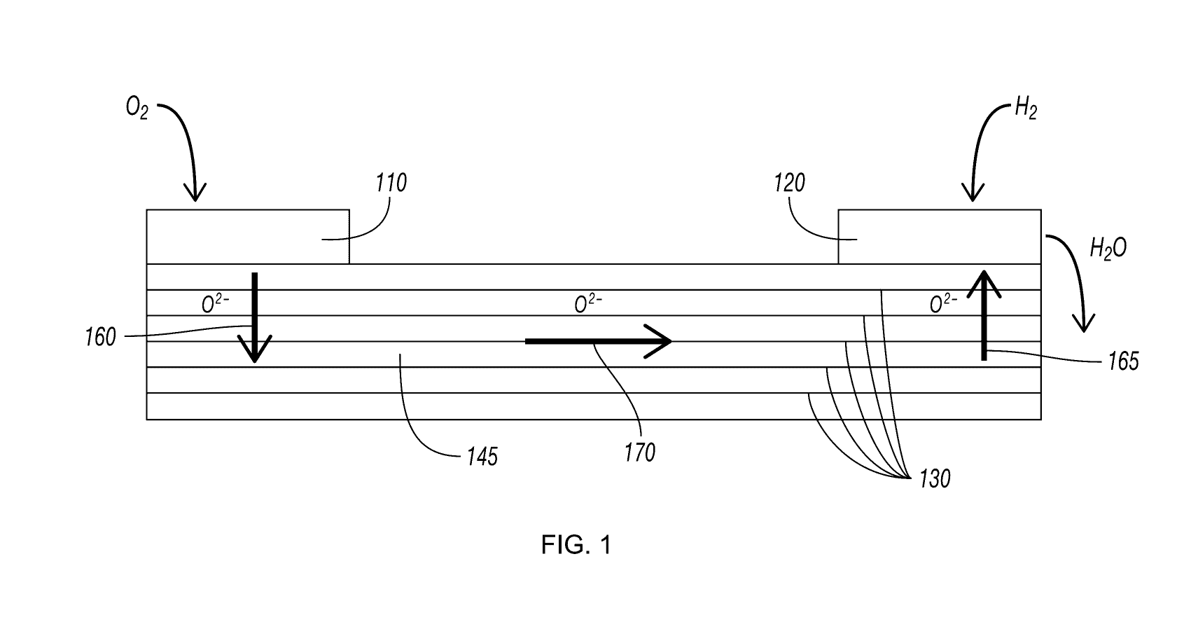

Further embodiments of the present invention provide one or more mechanisms by which ions move through the electrolyte. Without wishing to be bound by theory, it is believed that the enhanced performance of the solid oxide cells in certain embodiments of the present invention is due to increased ionic conductivity in the inventive electrolytes. And it is believed that the increased ionic conductivity is primarily interfacial conductivity. That is, oxygen ion conductivity along the interface between two different metal oxide layers explains the improved performance of the cell. Thus, in some embodiments, the electrolyte is adapted to allow ionic conductivity along one or more interfaces between two different metal oxide materials. In other embodiments the electrolyte is further adapted to allow ionic conductivity through the bulk of one or more metal oxide materials. FIGS. 1, 2, and 9 illustrate bulk diffusion, or ionic conductivity through the bulk of a metal oxide material (e.g., items 660 and 665 in FIG. 9), and interfacial diffusion, or ionic conductivity along the interfaces present in the electrolyte (e.g., item 670 in FIG. 9).

Further embodiments provide sequential formation of two or more metal oxides to form a metal oxide electrolyte. For example, a first metal compound is applied to a substrate such as an electrode, and converted to a first metal oxide. Depending on the amount of metal compound and the manner of application, the resulting first metal oxide is porous, in some embodiments. Then, a second metal compound is applied to the surface having the first metal oxide, and converted to a second metal oxide. Successive domains of first metal oxide and second metal oxide are formed on the surface by repeatedly applying and converting the respective metal compounds. In that way, a metal oxide electrolyte can be built on the substrate so that multiple interfaces between the first metal oxide and second metal oxide form. Depending on the amount, or if present in a composition, the concentration, of the metal compounds, the resulting metal oxide domains can have pores, voids, or discontinuities. Those defects can allow the penetration of subsequently applied metal compound into the metal oxide, and give rise to interfaces between the oxides that run roughly perpendicularly from the surface of the substrate. Without wishing to be bound by theory, those vertical interfaces can give rise to crystal structure defects between the two oxides and enhance ionic conductivity. In some embodiments, a superlattice can be formed of alternating interpenetrating layers of metal oxides.

Accordingly, some embodiments provide a method for forming a metal oxide electrolyte, comprising:

applying a first metal compound to a substrate;
converting at least some of the first metal compound to form a first metal oxide on the substrate; applying a second metal compound to the substrate comprising the first metal oxide; and
converting at least some of the second metal compound to form a second metal oxide on the substrate comprising the first metal oxide,
thereby forming the metal oxide electrolyte;
wherein the metal oxide electrolyte has an ionic conductivity greater than the bulk ionic conductivity of the first metal oxide and of the second metal oxide. Further embodiments provide applying additional first metal compound to the substrate comprising the first metal oxide and the second metal oxide; and
converting at least some of the additional first metal compound to form additional first metal oxide.

Still other embodiments of the present invention relate to applying additional second metal compound to the additional first metal oxide; and converting at least some of the additional second metal compound to form additional second metal oxide.

In some embodiments, metal oxides suitable for metal oxide electrolytes comprise zirconium oxides combined with various transition and/or rare earth metals, including, but not limited to, scandium, yttrium, erbium, ytterbium, europium, gadolinium, or dysprosium, or combinations thereof. In one embodiment, a metal oxide suitable for one or more layers of an electrolyte comprises zirconium oxide (ZrO₂) or yttria-stabilized zirconia (YSZ) Zr₍₁₋ₓ₎YₓO_{[2-(x/2)]}, x=0.08-0.20, or 0.10-0.50, or 0.15-0.20, in certain embodiments. In another embodiment, a suitable electrolyte metal oxide comprises scandia-stabilized zirconia (SSZ) Zr₍₁₋ₓ₎ScₓO_{[2-(x/2)]}, x=0.09-0.11. Additional suitable electrolyte zirconium compounds comprise zirconium silicate (ZrSiO₄), Zr_{0.85}Ca_{0.15}O_{1.85} or 3ZrO₂2CeO₂+10% CaO.

In another embodiment, metal oxides of an electrolyte comprise cerium oxides of the general formula Ce₍₁₋ₓ₎MₓO_{(2-δ)}, x=0.10-0.20, and δ=x/2. In some embodiments M is samarium or gadolinium to produce CeO₂—Sm₂O₃ or CeO₂—Gd₂O₃.

Additional metal oxides suitable for electrolytes of solid oxide cells of the present invention, comprise perovskite structured metal oxides. In some embodiments, perovskite structured metal oxides comprise lanthanum gallates (LaGaO₃). Lanthanum gallates, in some embodiments, are doped with alkaline earth metals or transition metals, or combinations thereof. In another embodiment, a perovskite structure metal oxide comprises lanthanum strontium gallium magnesium oxide (LSGM) La₍₁₋ₓ₎SrₓGa_{(1-y)}Mg_{y}O_{(3-δ)}, x=0.10-0.20, y=0.15-0.20, and δ=(x+y)/2.

In a further embodiment, metal oxides suitable for electrolytes comprise brownmillerites, such as barium indiate (Ba₂In₂O₆), non-cubic oxides such as lanthanum silicate, neodymium silicate, or bismuth based oxide, or combinations thereof.

Electrolytes of solid oxide cells, according to some embodiments of the present invention, comprise a plurality of nanocrystalline grains, the nanocrystalline grains comprising one or more of the metal oxides that are suitable for use as an electrolyte in a solid oxide cell. In some embodiments, the nanocrystalline grains have an average size of less than about 50 nm. In other embodiments, nanocrystalline grains of electrolyte layers have an average size ranging from about 2 nm to about 40 nm or from about 3 nm to about 30 nm. In another embodiment, nanocrystalline grains have an average size ranging from about 5 nm to about 25 nm. In a further embodiment, nanocrystalline grains have an average size less than about 10 nm or less than about 5 nm.

Electrolytes of solid oxide cells are substantially non porous, in some embodiments. In one embodiment, an electrolyte has a porosity less than about 20%. In another embodiment, an electrolyte has a porosity less than about 15% or less than about 10%. In a further embodiment, an electrolyte has a porosity less than about 5% or less than about 1%. In one embodiment, an electrolyte is fully dense meaning that the electrolyte has no porosity.

Once the metal oxide is formed, in some embodiments of the present invention, one or more epoxies can be applied to the metal oxide. In addition, or alternatively, epoxy can be applied to other components, such as one or more electrodes of the solid oxide cell. Epoxy can be used, in some embodiments of the present invention, to seal the solid oxide cell so that reactants from one side of the cell do not penetrate to the other side of the cell. Any suitable epoxy that can withstand the operating temperature of the solid oxide cell can be used alone or in combination. U.S. Pat. No. 4,925,886 to Atkins et al. discloses and claims epoxy compositions comprising two epoxies and having a usable temperature of at least 160° C., for example. U.S. Pat. No. 6,624,213 to George et al. reports tests of various epoxy compositions at 177° C., for further examples. The '886 patent and the '213 patent are incorporated by reference herein in their entireties.

In some embodiments, an electrolyte has a thickness ranging from about 1 nm to about 1 mm or from about 10 nm to about 500 μm. In other embodiments, an electrolyte has a thickness ranging from about 2 nm to about 25 nm, from about 5 nm to about 50 nm, from about 50 nm to about 250 nm, from about 100 nm to about 1 μm, or from about 500 nm to about 50 μm. In another embodiment, an electrolyte has a thickness ranging from about 750 nm to about 10 μm, or from about 1 μm to about 5 μm, or from about 1.2 μm to about 4 μm, or from about 1.5 μm to about 2 μm. In a further embodiment, an electrolyte has a thickness less than about 10 μm or less than about 1 μm. In one embodiment, an electrolyte has a thickness ranging from about 1 nm to about 100 nm or from about 50 nm to about 100 nm. Certain embodiments provide an electrolyte having a thickness greater than about 1 nm, greater than about 5 nm, greater than about 10 nm, greater than about 25 nm, greater than about 50 nm, greater than about 100 nm, greater than about 150 nm, or greater than about 200 nm. In still other embodiments, an electrolyte has a thickness greater than about 500 μm.

When the electrolyte has two or more layers of metal oxide material, the thickness of each layer is not limited. In some cases, the thickness of a given layer of metal oxide material is at least about 1 nm, at least about 2 nm, at least about 5 nm, at least about 10 nm, at least about 20 nm, at least about 50 nm, or at least about 100 nm. In other cases, the thickness of a given layer of metal oxide material is less than about 100 nm, less than about 50 nm, less than about 20 nm, less than about 10 nm, less than about 5 nm, or less than about 2 nm.

Further embodiments provide electrolytes with various regions adapted for ionic conductivity. In some cases, a region of an electrolyte is adapted to provide ionic conductivity through the bulk of a metal oxide material, and that region is proximal to an electrode. Additional embodiments provide an electrolyte having a first region adapted to allow ionic conductivity through bulk electrolyte material, wherein the first region is proximal to a first electrode; and

a second region adapted to allow ionic conductivity through bulk electrolyte material,
wherein the second region is proximal to a second electrode;
wherein the first region is separated from the second region by the at least one interface.

Another electrolyte appears in a further embodiment, wherein the first region is adapted to provide ionic conductivity in a first direction; the second region is adapted to provide ionic conductivity in a second direction; the at least one interface is adapted to provide ionic conductivity in a third direction; wherein the first direction is substantially antiparallel to the second direction, and the first direction and the second direction are substantially normal to the third direction. FIG. 9 illustrates such an embodiment. Item 636 is a region adapted to provide ionic conductivity in a first direction, such as illustrated by item 660. Item 638 is a region adapted to provide ionic conductivity in a second direction, such as is illustrated by item 665. Interfaces (630) are adapted to provide ionic conductivity in a third direction, such as is illustrated by items 670. Item 660 is antiparallel to item 665, and both are normal to items 670.

### The Electrodes

Certain embodiments of the present invention provide electrodes for the metal oxide cell. Any suitable electrode can be used in various embodiments of the present invention. To begin with, some embodiments provide a cell comprising a substrate with an electrolyte thereon having a one or more interfaces adapted to allow ionic conductivity along the interfaces, and two electrodes positioned such that the electrodes are electrically isolated from each other and in ionic communication with each other via the one or more interfaces of the electrolyte. In some embodiments, there is a plurality of interfaces in the electrolyte.

Electrodes of the present invention, in some embodiments, comprise silicon carbide doped with titanium. Certain embodiments comprise platinum, platinum oxide, YSZ, silver, and combinations of two or more thereof. In other embodiments, an electrode comprises La₁₋ₓSrₓMnO₃ [lanthanum strontium doped manganite (LSM)]. In another embodiment, an electrode comprises one or more porous steel alloys. In one embodiment, a porous steel alloy comprises steel alloy 52. In some embodiments, a porous steel alloy suitable for use as an electrode comprises steel alloy 316, stainless steel alloy 430, Crofer 22 APU® (Thyssen Krupp), E-Brite® (Alleghany Ludlum), HASTELLOY® C-276, INCONEL® 600, or HASTELLOY® X, each of which is commercially available from Mott Corporation of Farmington, Conn. Yet additional embodiments provide an electrode comprising nickel such as, for example, Nickel Alloy 200. Certain embodiments employ an electrode comprising porous graphite, optionally with one or more catalytic materials. In a further embodiment, an electrode comprises any metal or alloy known to one of skill in the art operable to serve as an electrode. Some embodiments of the present invention provide electrodes comprising a metal, a metal carbide, or a combination thereof. Certain additional embodiments provide an electrode comprising titanium silicate carbide. In some of those embodiments, the electrode material may have electrical, structural, and mechanical properties that are better than those of ceramic electrodes.

Electrodes in certain embodiments of the present invention comprise platinum oxide, platinum, YSZ, silver particles, nickel particles, or a combination of two or more thereof. Such a composition can be made by depositing on the layered electrolyte, optionally into an exposure made in the layered electrolyte, a composition comprising a Pt(II) salt, yttrium carboxylates, zirconium carboxylates, silver particles, nickel particles, or a combination thereof. Other optional ingredients include, but are not limited to, soda glass powder, metal colloid, and silver-coated nickel particles. Particle sizes for the various particles and powders is not limited and can be on the micrometer scale in one embodiment. One Pt(II) salt is Pt (II) 2,4-pentanedionate available from Alfa Aesar. Optionally, platinum oxide can be reduced to form metallic platinum by any suitable method, such as, for example, baking in an Ar/H₂ atmosphere at 600° C. for 15 minutes.

Electrodes, according to further embodiments of the present invention, are porous. In some embodiments, an electrode has a porosity ranging from about 5% to about 40%. In another embodiment, an electrode has a porosity ranging from about 10% to about 30% or from about 15% to about 25%. In a further embodiment, an electrode has a porosity greater than about 40%. An electrode, in some embodiments, has a porosity ranging from about 40% to about 80%. In one embodiment, an electrode has a porosity greater than about 80%.

An electrode, in one embodiment, is an anode. An electrode, in another embodiment, is a cathode. In some embodiments, a metal oxide coating of an electrode can protect the electrode substrate from corrosion and/or degradation.

### Catalytic Sites

Electrodes, electrolytes, or both, can comprise one or more catalytic materials in further embodiments. Catalytic materials can comprise transition metals including, but not limited to, platinum, palladium, rhodium, nickel, cerium, gold, silver, zinc, lead, ruthenium, rhenium, or mixtures thereof. Catalytic materials, in some embodiments, are disposed in one or a plurality of metal oxide layers coating the substrate of an electrode. The combination of a metal oxide with pure metals or alloys, in some embodiments, produces a cermet. Electrodes of solid oxide fuel cells further comprising catalytic materials can function as fuel reformers operable to convert hydrocarbon fuels into hydrogen for subsequent use in the solid oxide fuel cell, in some embodiments. Moreover, electrodes further comprising catalytic materials can function as fuel reformers upstream and independent from the solid oxide fuel cell in other embodiments.

Electrodes, electrolytes, or both, comprising catalytic materials can additionally demonstrate compositional gradients based on the distribution of the catalytic materials in the plurality of metal oxide layers. In one embodiment, an electrolyte is formed on a substrate and comprises a plurality of metal oxide layers disposed on the substrate, and an electrode on the electrolyte, wherein metal oxide layers closer to the electrode comprise greater amounts of catalytic material than metal oxide layers further from the electrode. Moreover, in another embodiment, metal oxide layers further from the substrate comprise greater amounts of catalytic material than metal oxide layers closer to the substrate. In one embodiment, for example, metal oxide layers further from the substrate comprise about 5 weight percent catalytic material while metal oxide layers closer to the substrate comprise about 1 weight percent catalytic material.

Catalytic sites can be formed by any suitable method. One method involves forming the corresponding metal oxide by applying a metal compound, heating in air at 450° C., and thereby forming the metal oxide. Then, the metal oxide is reduced by any suitable method. For example, platinum oxide can be reduced to form metallic platinum by baking in an Ar/H₂ atmosphere at 600° C. for 15 minutes.

### The Electrode-Electrolyte Transition Element

Applicants have unexpectedly found that an electrode-electrolyte transition element improves the performance of the solid oxide cell, in some embodiments of the present invention. A given cell, containing a cathode and an anode, can have one or two electrode-electrolyte transition elements, one for each electrode, in some cases. An electrode-electrolyte transition element comprises colloidal silver, platinum oxide, yttria-stabilized zirconia, or a combination of two or more thereof, in some embodiments. Certain embodiments provide a first electrode-electrolyte transition element, a second electrode-electrolyte transition element, or both, comprising, proximal to the respective electrode, a first material comprising yttria-stabilized zirconia, platinum oxide, and colloidal silver;

proximal to the first material, a second material comprising platinum oxide; proximal to the second material and to the electrolyte, a third material comprising yttria-stabilized zirconia and platinum oxide; wherein first electrode-electrolyte transition element, the second electrode-electrolyte transition element, or both, provide the ionic conductivity between the respective electrode and the electrolyte.

In some cases, an electrode comprises for example, three ingredients, while the electrode-electrolyte composition comprises fewer ingredients. For example, as explained above, an electrode can comprise yttria-stabilized zirconia, platinum oxide, and colloidal silver, and the electrode-electrolyte transition element contains no colloidal silver. In other embodiments, an electrode-electrolyte transition element contains one or more ingredients present in the electrode, but in a lesser concentration. Thus, in such embodiments, the electrode-electrolyte transition element provides a concentration gradient between the electrode and the electrolyte.

Other embodiments provide a first electrode-electrolyte transition element, a second electrode-electrolyte transition element, or both, comprising a catalytic material. For example, such a catalytic material can be, but is not limited to, metallic platinum, palladium, rhodium, nickel, cerium, gold, silver, zinc, lead, ruthenium, rhenium, or a combination thereof. In some cases, the catalytic material is metallic platinum.

### Minaturization

Applicants have unexpectedly found on certain dimensional scales, a solid oxide cell of the present invention can be reduced in size without sacrificing cell performance. For example, reducing the dimensions of a cell from 40 mm×20 mm to 20 mm×10 mm cuts the area of the cell by a factor of four. However, the electrical power output of the cell operated in fuel cell mode does not change. Without wishing to be bound by theory, it is believed that various factors causing performance loss at a larger scale are reduced at the smaller scale, thereby making up for the expected loss in cell performance at the smaller scale. Chief among those factors is the relative proximity of the anode to the cathode at larger scale, it is believed. The closer the anode to the cathode, the better the cell performs, it is further believed. This reduction in size without loss of performance has been observed at the centimeter and millimeter scale, and is expected to continue into the micron scale. This surprising result affords an opportunity to reduce cell size and material cost, while increasing cell longevity and performance. It also urges the development of systems employing larger numbers of smaller cells, rather than a fewer number of large, smaller cells. Accordingly, Applicants have developed what are referred to herein as modules, which can be thought of as a convenient collection of cells, and a module assembly, which is a convenient collection of modules.

Thus, some embodiments of the present invention provide planar layered solid oxide electrolyte wherein the cell occupies an area smaller than those conventionally known. In some cases, the area of an electrolyte, including the area “covered” by electrodes, is less than about 1000 mm², less than about 500 mm², less than about 200 mm², less than about 100 mm², less than about 10 mm², or less than about 1 mm².

### Modules

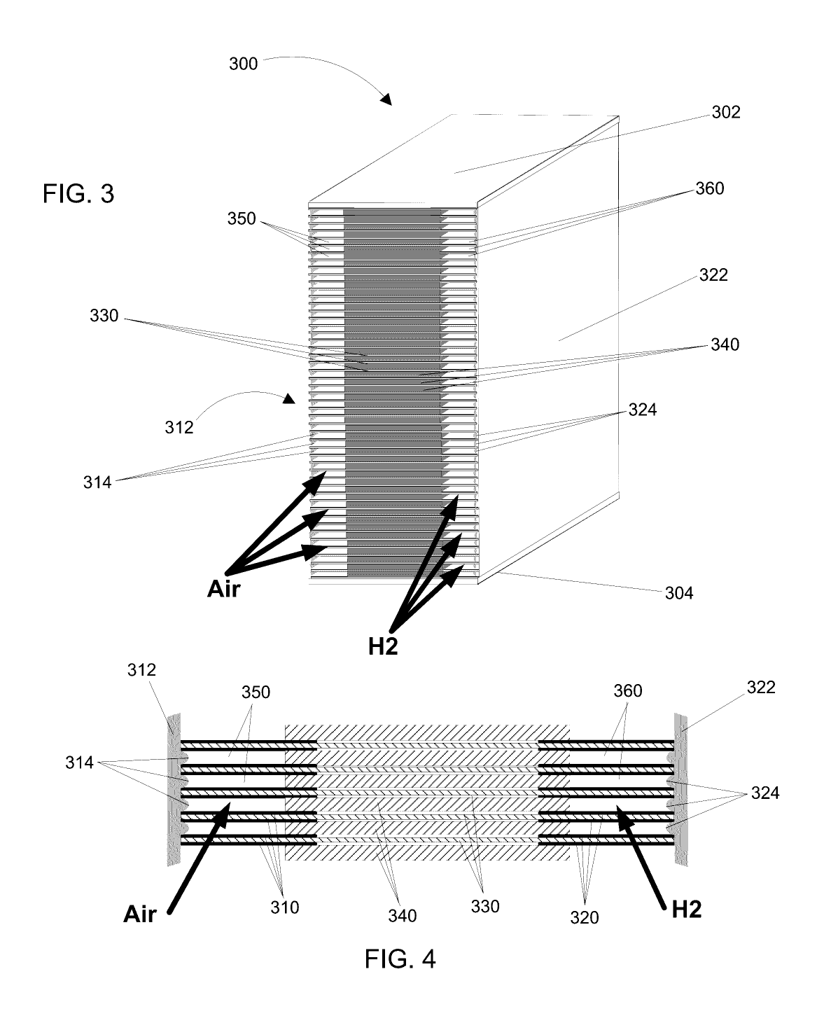

As stated above, some embodiments of the present invention provide cells on substrates. Those substrates can be designed so that cells can be combined, such as by stacking. As the skilled artisan knows, when batteries for example are gathered and electrically combined in series or in parallel, or both, the voltage, current, or both can be increased relative to the performance of a single cell. So it is in the present invention. Certain embodiments provide a plurality of cells arranged in a module. A module according to the present invention is not limited in size, shape, or arrangement of cells. FIGS. 3-4, for example, show planar substrates having cells and layered electrolytes on two sides stacked in the form of a module. A high temperature silicone rubber spacer separates the substrates, supporting each one by contacting the layered electrolyte (“Ionic Conductor” in the figures) formed on the substrate. The spacers, together with a conductive high temperature epoxy, form oxidant channels for airflow over the cathodes, and fuel channels for hydrogen gas flow over the anodes. Applicants have unexpectedly found that glass substrates with silicone rubber spacers and layered electrolytes having thicknesses on the nanoscale are surprisingly able to withstand the conditions of manufacture and operation.

Accordingly, yet additional embodiments of the present invention provide a substrate having two electrodes on its front surface electrically isolated from each other and in ionic communication with each other via the interfaces on the front surface; and two electrodes on the back surface electrically isolated from each other and in ionic communication with each other via the interfaces on the back surface.

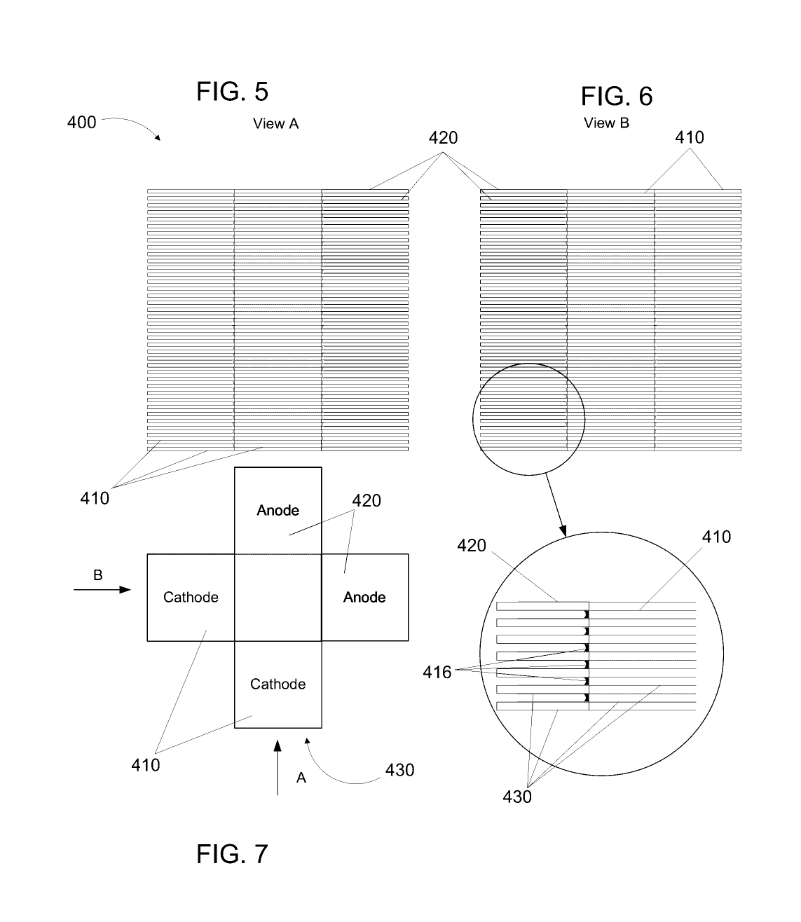

A cross-shaped module (400) is seen in FIGS. 5-7. The cross-shaped module (400) is made from rectangular substrates (430) such as glass microscope slides that can be coated on one side or on both sides with electrolyte (not shown), thereby allowing for twice as many cells in the same volume. For each substrate (430), a cathode (410) is formed on one edge, and an anode (420) is formed on the opposite edge. A spacer element (not shown), such as the high temperature silicone rubber spacer optionally used as the spacer (340) in FIGS. 3-4, can be used to separate substrates (430). Or, the glass substrates (430) can be stacked on each other in alternating fashion to form the cross shape, with care being taken to electrically insulate the cathodes (410) from the anodes (420). The call-out in FIG. 6 shows that a ceramic or solder glass powder sealant (416) can assist with sealing the module, keeping the oxygen and hydrogen or other fuel separated.

As used herein, a module is a stack or other coherent collection of cells, such as those seen in FIGS. 3-7. In some embodiments, a module is a stack of cells comprising spacer elements separating and supporting the cells. When modules are gathered together, module assemblies are formed.

Further embodiments contemplate a module as comprising a plurality of cells on a surface. A substrate, such as a piece of glass, can have numerous cells assembled on its surface. Oxygen-containing fluid conduits, fuel-containing fluid conduits, electrical contacts, barriers for separating the two fluids, and optionally heat sinks can be assembled onto the glass. Such a planar module can be collected into a module assembly, optionally with the barriers for separating the two fluids acting as spacer elements to separate one planar module from the next.

### Module Assemblies

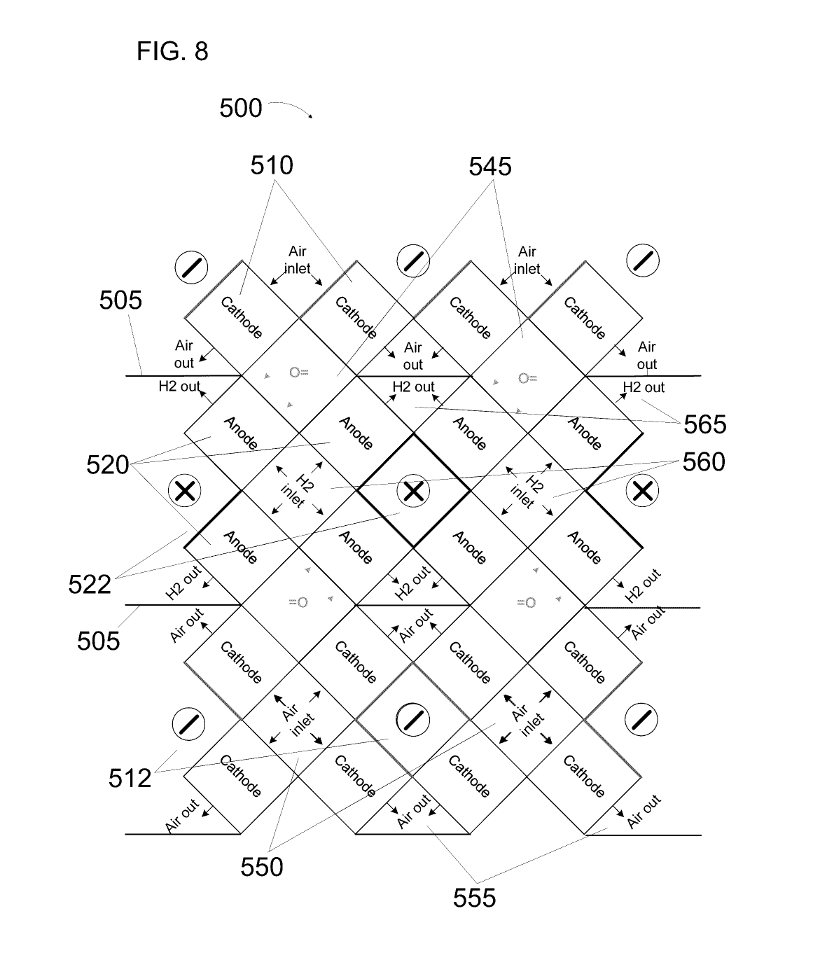

As stated above, some embodiments of the present invention provide module assemblies. A module assembly comprises a plurality of modules. In some embodiments, a module assembly comprises a plurality of stacked cells. The module assembly provides certain advantages, as can be appreciated by reference to FIG. 8. There, cell modules such as those depicted in FIGS. 5-7 (viewed normal to the planar cells; see FIG. 7) are arranged so that air flow, hydrogen flow, and electrical connections can be shared among modules. Thus, certain embodiments provide module assemblies in which an oxygen-containing fluid conduit is shared by a plurality of modules. Further embodiments provide module assemblies in which a fuel-containing fluid conduit is shared by a plurality of modules. Additional embodiments provide module assemblies in which a positive electrical conduit is shared by a plurality of modules. Yet other embodiments provide module assemblies in which a negative electrical conduit is shared by a plurality of modules.

Another advantage of a module assembly is the relative ease of repair in certain embodiments: if a module ceases working optimally, that module can be removed from the module assembly and replaced with a fresh module, for example. The removed module can be repaired or recycled in some cases. In other cases, cells that still operate optimally can be recovered, and a new module built.

Module assemblies of the present invention are not limited by size, shape, number of cells, or number of modules. Some embodiments can provide an enormous amount of electrical power by including a large number of cells organized in a plurality of modules. Certain embodiments provide a module assembly capable of generating at least about 1000 W, at least about 10,000 W, at least about 100,000 W, at least about 1 MW, at least about 10 MW, or at least about 100 MW of electrical power.

Heat generated by the operation of a cell, a module, or a module assembly can be dealt with in any suitable fashion. In some embodiments, the flow of oxygen-containing fluid, fuel-containing fluid, or both is increased or decreased to aid in maintaining the desired operating temperature of the cell, module, or module assembly. For example, the fuel-containing fluid can be hydrogen gas flowing past the anodes in the module assembly. In the vicinity of the anodes, the hydrogen will pick up water vapor developed as the module assembly operated in fuel cell mode. The steam-laden hydrogen gas is then passed to a liquid nitrogen-cooled condenser apparatus, whereby water condenses out of the hydrogen gas. The dry hydrogen is returned to the anodes, and in this manner transports thermal energy away from the cells. In other embodiments, one or more heat sinks are in thermal communication with the cell, module, or module assembly. A heat sink is any thermal energy-absorbing or conducting material that allows heat generated in a cell to move away from the cell. For example, a metal in thermal communication with a cell can dissipate heat from the cell, such as by heat transfer along the metal. In another example, a module or a module assembly will have a cooling fluid circulating in thermal communication with the cells of the module or module assembly. Looking at FIG. 8, the electrical conduits marked by “(−)” that is the negative electrical conduit (512) and “(+)” that is the positive electrical conduit (522) can be in the form of tubes circulating a cooling fluid throughout the module. The cooling fluid is then passed to a heat exchanger (not shown), for example, thereby dissipating the heat generated during operation.

### Operation of Solid Oxide Cells

Turning now to components that can be included in solid oxide fuel cells, solid oxide fuel cells of the present invention comprise an air electrode. The air electrode of a solid oxide fuel cell operates as a cathode to reduce oxygen molecules thereby producing oxygen anions for subsequent transport through the electrolyte. In some embodiments, an air electrode comprises p-type semiconducting oxides such as lanthanum manganite (LaMnO₃). Lanthanum manganite can be doped with rare earth elements, such as strontium, cerium, and/or praseodymium to enhance conductivity. In one embodiment, an air electrode comprises La₁₋ₓSrₓMnO₃ [lanthanum strontium doped manganite (LSM)]. In another embodiment, an air electrode comprises lanthanum strontium ferrite or lanthanum strontium cobaltite or a combination thereof.

Air electrodes, according to some embodiments of the present invention, are porous. In one embodiment, an air electrode has a porosity ranging from about 5% to about 30%. In another embodiment, an air electrode has a porosity ranging from about 10% to about 25% or from about 15% to about 20%. In a further embodiment, an air electrode has a porosity greater than about 30%. An air electrode, in some embodiments, has a porosity ranging from about 30% to about 60% or from about 40% to about 80%. In one embodiment, an air electrode has a porosity greater than about 80%.

In addition to an air electrode, a solid oxide fuel cell comprises a fuel electrode. A fuel electrode, in some embodiments, comprises one or more catalytic materials. Catalytic materials, as provided herein, comprise transition metals including, but not limited to, platinum, palladium, rhodium, nickel, cerium, gold, silver, zinc, lead, ruthenium, rhenium, or mixtures thereof. In one embodiment, a fuel electrode comprises zirconia (ZrO₂) combined with Ni. Yttria-stabilized zirconia (YSZ), Zr₍₁₋ₓ₎YₓO_{[2-(x/2)]}, for example, can be combined with Ni to produce a Ni—YSZ fuel electrode. Catalytic materials, in some embodiments, are incorporated into metal oxide compositions of fuel electrodes in an amount ranging from about 0.5 to about 10 weight percent. In other embodiments, catalytic materials are incorporated into metal oxide compositions of fuel electrodes in an amount less than about 5 weight percent, less than about 0.5 weight percent, or greater than about 10 weight percent.

Fuel electrodes, according to some embodiments of the present invention, are porous. In one embodiment, a fuel electrode has a porosity ranging from about 5% to about 40%. In another embodiment, a fuel electrode has a porosity ranging from about 10% to about 30% or from about 15% to about 25%. In a further embodiment, a fuel electrode has a porosity greater than about 40%. A fuel electrode, in some embodiments, has a porosity ranging from about 40% to about 80%. In still other embodiments, a fuel electrode has a porosity greater than about 80%.

In some embodiments, one or both of the air electrode and fuel electrode comprise platinum oxide, yttria-stabilized zirconia, silver particles, nickel particles, silver-coated nickel particles, or a combination of two or more thereof. Other embodiments provide one or both electrodes contacting only one metal oxide material of an electrolyte comprising an interface between two metal oxide materials. Still other embodiments provide one or both electrodes contacting one or more interfaces between two metal oxide materials in a layered solid oxide electrolyte.

In general, a solid oxide cell of the present invention can be operated at any suitable temperature. Applicants have invented embodiments that work at a temperature as low as 160° C. Performance improves as temperature increases from there. In certain cases, an increase of 80° C. in operating temperature has been observed to cause a ten-fold increase in ionic conductivity. The skilled artisan will appreciate that a balance must be struck between optimal performance and the longevity of the materials. In some embodiments, the solid oxide cell is operated at a temperature of at least about 160° C., at least about 200° C., at least about 300° C., at least about 400° C., at least about 500° C., at least about 600° C., at least about 700° C., at least about 800° C., at least about 900° C., or at least about 1000° C. In other embodiments, the solid oxide cell is operated at a temperature of no more than about 1000° C., no more than about 900° C., no more than about 800° C., no more than about 700° C., no more than about 600° C., no more than about 500° C., no more than about 400° C., no more than about 300° C., or no more than about 200° C.

Certain embodiments provide an oxygen-containing fluid flowing over an electrode such as a cathode. Such a fluid can be in any suitable form, such as gas or liquid. The oxygen-containing fluid is not limited by composition, and can be air, dry air, pure oxygen, or oxygen mixed with another gas such as nitrogen, argon, helium, neon, or combinations thereof. The oxygen-containing fluid can contact the electrode at any suitable pressure, such as, for example, atmospheric pressure, less than atmospheric pressure, or greater than atmospheric pressure. Certain embodiments provide the oxygen-containing fluid to the cathode at a pressure greater than about 1 atm, greater than about 5 atm, or greater than about 10 atm. In some cases, the oxygen-containing fluid is preheated. In other cases, the oxygen-containing fluid is precooled.

Other embodiments provide a fuel-containing fluid. Such a fluid is not limited by form, temperature, pressure, or composition. In some cases, the fuel-containing fluid is hydrogen gas, or contains molecular hydrogen. Hydrogen can be in the presence of an inert carrier gas, such as, for example, nitrogen, argon, helium, neon, or combinations thereof. The fuel-containing fluid can contact the electrode at any suitable pressure, such as, for example, atmospheric pressure, less than atmospheric pressure, or greater than atmospheric pressure. Certain embodiments provide the fuel-containing fluid to the anode at a pressure greater than about 1 atm, greater than about 5 atm, or greater than about 10 atm. In some cases, the fuel-containing fluid is preheated. In other cases, the fuel-containing fluid is precooled. In still other cases, the fuel-containing fluid is the product of the reformation of hydrocarbons.

### Electrolyzers

Some embodiments of the present invention provide solid oxide electrolyzer cells or a component thereof comprising a metal oxide. In certain embodiments, the electrolyzer cell or component thereof is substantially identical in manufacture and composition as the other solid oxide cells and components described herein.

In some of those embodiments of the present invention where the same cell can function as an electrolyzer cell and alternately as a fuel cell simply by reversing the flow of electrons, the cathode of the electrolyzer corresponds to the fuel electrode of the fuel cell; and the anode of the electrolyzer corresponds to the air electrode of the fuel cell. Those of ordinary skill in the art recognize that oxidation occurs at the anode, and reduction occurs at the cathode, so the name of a given electrode may differ depending on whether the cell is operating as an electrolyzer or as a fuel cell.

In other embodiments, electrons flow in the same direction, regardless of whether the cell is electrolyzing or producing electricity. This can be accomplished, for example, by supplying oxygen anions to a given electrode in electrolysis mode, and alternately supplying hydrogen to the same electrode in fuel cell mode. Such an electrode will function as the oxidizing anode in either mode.

Accordingly, some embodiments of the present invention provide a solid oxide electrolyzer cell, comprising a first electrode, a second electrode, and a metal oxide electrolyte interposed between the first electrode and the second electrode.

The present invention also provides, in some embodiments, a method for making a product, comprising:

providing a solid oxide cell comprising a first electrode, a second electrode, and a metal oxide electrolyte interposed between the first electrode and the second electrode, wherein the metal oxide electrolyte has an ionic conductivity greater than the bulk ionic conductivity of the metal oxide;
contacting the first electrode with a reactant; and
supplying electrical energy to the first electrode and the second electrode thereby causing the reactant to undergo electrochemical reaction to yield the product.

The skilled electrochemist will appreciate that a complete circuit is necessary for electrical energy to cause electrochemical reaction. For example, at least one ion may traverse the metal oxide electrolyte to complete the electrical circuit at the second electrode. Moreover, a second product may be formed at the second electrode due to electrochemical reaction. Therefore, some embodiments further provide for contacting the second electrode with a second reactant, thereby causing the second reactant to undergo electrochemical reaction to yield a second product. Contacting an electrode and supplying electrical energy can occur in any suitable order. In a continuous process, electrical energy supply is maintained while additional reactant(s) enter the cell and product(s) are removed.

Any suitable reactant can be supplied to an electrode for electrochemical reaction. Suitable reactants include, but are not limited to, water such as, for example, pure water, fresh water, rain water, ground water, salt water, purified water, deionized water, water containing a ionic substance, brine, acidified water, basified water, hot water, superheated water, steam, carbon dioxide, carbon monoxide, hydrogen, nitrous oxides, sulfur oxides, ammonia, metal salts, molten metal salts, and combinations thereof. Ionic substances include those substances that release a ion when placed in contact with water, and include, but are not limited to, salts, acids, bases, and buffers. Reactants, and for that matter, products, can be in any suitable form, including solid, liquid, gas, and combinations thereof. Solid reactants and/or solid products lend themselves to batch processes, although suitable methods for continuously removing a solid product from a cell can be employed. Fluid reactants and products can appear in either batch or continuous processes. Optionally, heat energy is applied to the reactant, the product, at least one electrode, the metal oxide, the cell, or a combination thereof.

Some embodiments provide a sacrificial electrode. A sacrificial electrode itself reacts in the electrolysis process, and is thereby consumed or rendered unreactive as the reaction proceeds. For example, a zinc electrode can be consumed in a suitable solid oxide cell reaction, yielding Zn²⁺ and two electrons per atom of zinc consumed. In another example, an electrode can become coated and thereby rendered unreactive by solid product forming on its surface. The unreactive electrode can be removed from the cell, and the product extracted from the electrode, or the product can be used on the electrode in another process. The electrode then can be regenerated, recycled, or discarded. Alternatively, a sacrificial electrode can be made to gradually insert into a cell at a rate consistent with the rate at which the electrode is consumed.

A reactant undergoing electrochemical reaction can be oxidized and/or reduced, and chemical bonds may form and/or break. For example, when water undergoes electrolysis, hydrogen-oxygen bonds break, H⁺ is reduced to H⁰, O²⁻ is oxidized to O⁰, and H₂ and O₂ form, in some circumstances. Hydrogen peroxide and other species may form in other circumstances. The skilled artisan will appreciate that many electrode half reactions can be substituted so that any variety of anions, cations, and other species may result from electrochemical reaction.

In one embodiment, water containing NaCl can be electrolyzed to form hydrogen gas and NaOH at the cathode, and chlorine gas at the anode, in the so-called chlor-alkali process:

2NaCl(aq)+2H₂O(I)→2NaOH(aq)+Cl₂(g)+H₂(g)

A solid oxide cell arranged to carry out that reaction, in some embodiments, provides water containing a high concentration of NaCl (for example, saturated) to a first electrode that will act as an anode, and provides water to a second electrode that will act as a cathode. The cell also provides liquid effluent collection to remove the depleted NaCl solution from the anode, and NaOH-containing water from the cathode. The cell further provides gas effluent collection to remove chlorine gas from the anode and hydrogen gas from the cathode. Optionally, the hydrogen and chlorine can be subject to electrochemical reaction to release the electrochemical energy stored by the foregoing electrolysis, or they can be used for other industrial processes, such as the synthesis of sodium hypochlorite.

The present invention also provides methods for storing electrochemical energy. In some embodiments, a reactant is supplied to an electrode of a solid oxide cell, the reactant undergoes one or more electrochemical reactions and yields a fuel, thereby storing electrochemical energy. The electrochemical reaction may also yield other products, such as cations, anions, and other species, some of which may form at a second electrode of the solid oxide cell that completes an electrical circuit. A first electrode and a second electrode are separated by a metal oxide electrolyte in the solid oxide cell. The fuel can be subjected to energy conversion processes such as reverse electrochemical reaction in a fuel cell or battery, combustion, and the like to release the stored electrochemical energy.

In one embodiment, electrochemical energy is stored by providing a reactant to a cathode; reducing the reactant at the cathode to release an anion and a fuel; storing the fuel; transporting the anion through a metal oxide electrolyte to anode; and oxidizing the anion. Optionally, the oxidized anion is stored as well, separately from the stored fuel. Thus, in one embodiment, water in a suitable form is supplied to a cathode, at which it is reduced to hydrogen (H₂) and oxygen anion (O²⁻); the hydrogen is collected and stored, while the oxygen anion diffuses through a solid metal oxide electrolyte to an anode where the oxygen anion is oxidized to oxygen (O₂). Optionally, in the foregoing non-limiting example, the oxygen is collected and stored as well.

When desired, the stored hydrogen can be fed to any suitable fuel cell, including but not limited to the cell that produced the hydrogen, and the hydrogen can be oxidized to release the stored electrochemical energy. Any suitable gas can be fed to the air electrode of the fuel cell, such as, for example, the optionally-stored oxygen, other oxygen, other oxygen-containing gas such as air, and combinations thereof. Alternatively, the stored hydrogen can be combusted with oxygen to propel a rocket, drive a piston, rotate a turbine, and the like. In other embodiments, the stored hydrogen can be used in other industrial processes, such as petroleum cracking.

Some embodiments involve those reactants that yield the high energy materials commonly found in primary (nonrechargeable) and secondary (rechargeable) batteries. For secondary battery materials, the low-energy (discharge) state materials may be produced, since secondary batteries can be charged before first use. Such materials include, but are not limited to, MnO₂, Mn₂O₃, NH₄Cl, HNO₃, LiCl, Li, Zn, ZnO, ZnCl₂, ZnSO₄, HgO, Hg, NiOOH, Ni(OH)₂, Cd, Cd(OH)₂, Cu, CuSO₄, Pb, PbO₂, H₂SO₄, and PbSO₄.

At least some embodiments of fuel cells described above can be used to provide electrolyzer cell embodiments of the present invention. While fuel cell embodiments optionally employ one or more of fuel supply, air or oxidizer supply, interconnects, and electrical energy harvesting means (e.g., wires forming a circuit between the fuel and air electrodes' interconnects), electrolyzer cell embodiments optionally employ one or more of reactant supply, fuel collection, interconnects, and electrical energy supply. Optionally, electrolyzer cell embodiments also provide collection means for other products in addition to fuel. The reactant supply provides any suitable reactant for electrolysis. Fuel collection, in some embodiments, involves collecting hydrogen for storage and later use. Storage vessels, metal hydride technology, and other means for storing hydrogen are known in the art. Fuel collection, in other embodiments, involves collection of, for example, carbon-coated electrodes for later oxidation. Alternatively, carbon can be formed into fluid hydrocarbon for easy storage and later combustion or reformation. Hydrocarbon formation requires a supply of hydrogen molecules, atoms, or ions in a suitable form to combine with carbon at the cathode, in some embodiments. Other product collection involves, in some embodiments, the collection of oxygen for storage and later use.

In still other embodiments, an electrolyzer cell is capable of performing other electrolysis tasks, such as electroplating. In such embodiments, a metal oxide functions as a solid electrolyte shuttling a ion to complete an electrical circuit.

In some embodiments, the electrodes of the electrolyzer cell are adapted for the particular electrochemistry expected to occur at the given electrode. For example, the electrode can comprise one or more catalytic materials to facilitate the electrochemical reaction.

### Sensors

Some embodiments of the present invention provide solid oxide sensors or components thereof. Like the fuel cells and electrolyzer cells described herein, sensors of the present invention comprise a metal oxide electrolyte. In some embodiments, at least one ion passes through that metal oxide electrolyte during cell operation. In other embodiments, the solid oxide cells useful as sensors or components thereof are substantially identical to the solid oxide cells and components described above. The metal oxide electrolyte of sensors in certain embodiments has been made according to a process comprising:

applying a metal compound to a substrate, and
converting at least some of the metal compound to a metal oxide,
wherein the metal oxide electrolyte has an ionic conductivity greater than the bulk ionic conductivity of the metal oxide.

Sensors according to various embodiments of the present invention can be used to detect any suitable analyte or analytes. Oxygen sensors, useful as lambda sensors in automotive exhaust systems, or as oxygen partial pressure detectors in rebreather systems, represent some applications for embodiments. Other sensors, such as gas sensors including but not limited to CO, CO₂, H₂, NOₓ, and SOₓ; ion sensors including but not limited to pH meters, K⁺, and Na⁺; biosensors including but not limited to glucose sensors and other enzyme electrodes; electrochemical breathalyzers; and electronic noses; represent other applications for embodiments of the present invention. Many such sensors function at least in part due to the diffusion of an ion through an electrolyte, which electrolyte comprises a metal oxide.

Accordingly, additional embodiments provide a method for detecting an analyte, comprising:

providing a sensor for the analyte, wherein the a sensor comprises a metal oxide made by a process comprising:
applying a metal compound to a substrate, and
converting at least some of the metal compound to the metal oxide, wherein the metal oxide electrolyte has an ionic conductivity greater than the bulk ionic conductivity of the metal oxide; and
passing an ion through the metal oxide to detect the analyte. Passing an ion through a metal oxide can include any suitable transport mechanism, such as, for example, diffusion. In addition, movement along metal oxide crystal grain boundaries represents another transport mechanism, in some embodiments. Detecting an analyte can indicate obtaining any useful information about the analyte, such as, for example, determining its mere presence, concentration, partial pressure, oxidation state, or combinations thereof. And, sensors of the present invention can be designed for any suitable environment, such as solid, semisolid (e.g., soil), liquid, gas, plasma, and combinations thereof. Also, such sensors can be designed for any suitable operating temperature, ranging from the very cold to the very hot. Some solid oxide cells useful as sensors according to the present invention have an operating temperature of below about −195° C., below about −182° C., below about −77° C., from about −78° C. to about 0° C., from about 0° C. to about 100° C., from about 100° C. to about 400° C., from about 400° C. to about 600° C., from about 600° C. to about 900° C., from about 900° C. to about 1200° C., or above about 1200° C. Other embodiments useful as sensors have operating temperatures below about 0° C., above about 0° C., above about 100° C., or above about 500° C.

A few embodiments of the present invention provide solid oxide cells, useful as sensors, that enjoy one or more advantages over conventional sensors. In some embodiments, the metal oxide has a certain thickness, thinner than conventional sensors. In other embodiments, the solid oxide cell operates at a lower temperature, compared to conventional sensors. Still other embodiments provide smaller sensors. Even other embodiments provide sensors made from less-expensive materials. Additional embodiments have better-matched coefficients of thermal expansion between two or more materials in the cell. Still other embodiments provide one or more concentration gradients, one or more porosity gradients, or combinations thereof.

Further embodiments of the present invention provide a sensor comprising at least two electrodes separated by a layered metal oxide that functions as an electrolyte. In some of those embodiments, the voltage difference between the at least two electrodes corresponds to the concentration of the analyte being detected at one of the electrodes. A first electrode functions as a reference electrode, and is exposed to a reference environment. Suitable reference environments include, but are not limited to, air, vacuum, standard solutions, and environments of known or controlled composition. In some embodiments, the reference environment is formed by arranging one or more materials that substantially isolate the reference electrode from the environment being measured. The second electrode is exposed to the environment being measured. Optionally, the second electrode comprises one or more catalytic materials. In operation, the first and second electrodes are placed in electrical communication with one or more devices that can measure, for example, the voltage difference, the current, the resistance, or combinations thereof, between the two electrodes. Such devices are known in the art. Optionally, heat or cooling can be supplied to one or both electrodes, the electrolyte, or combinations thereof. Heat or cooling can come from any suitable source, such as, for example, one or more electrical resistance heaters, chemical reaction, thermal fluid in thermal communication with the sensor, the measured environment, and combinations thereof.

In some embodiments, a reference voltage is supplied to the electrodes, and the current needed to maintain the reference voltage corresponds to the concentration of the analyte being measured. For example, U.S. Pat. No. 7,235,171, describes two-electrode hydrogen sensors comprising barium-cerium oxide electrolyte. The '171 patent also indicates that various other metal oxides also function as electrolytes in hydrogen sensors, including selenium cerium oxides, selenium cerium yttrium oxides, and calcium zirconium oxides, which conduct protons, and oxygen anion conductors. The '171 patent is incorporated herein by reference in its entirety.

In other embodiments, a gas permeable porous platinum measuring electrode is exposed to a measured environment that contains a partial pressure of oxygen. A metal oxide, such as, for example, yttria-stabilized zirconia, separates the measuring electrode from a gas permeable porous platinum reference electrode that is exposed to air. The voltage difference, current, or both between the electrodes can be measured and correlated to the difference of partial pressure of oxygen between the measured environment and air. In some embodiments, the measured environment is an exhaust stream from the combustion of hydrocarbons.

In still other embodiments, at least two pairs of electrodes appear, wherein a layered metal oxide electrolyte separates the electrodes in each pair. One of the two pairs functions as a reference cell, while the other of the two pairs functions as a measuring cell, in some embodiments. Further embodiments provide, in a first pair of electrodes, a reference electrode exposed to a reference environment and a Nernst electrode exposed to the measured environment. A metal oxide that functions as an electrolyte is situated between the reference electrode and the Nernst electrode. In a second pair of electrodes, an inner pump electrode is separated from an outer pump electrode, with a metal oxide functioning as an electrolyte situated between the inner and outer pump electrodes. The inner pump electrode and the Nernst electrode are exposed to the environment to be measured optionally through a diffusion barrier. In operation, an external reference voltage is applied across the pump electrodes. The current needed to maintain the reference voltage across the pump electrodes provides a measure of the analyte concentration in the measured environment. For a conventional broadband lambda sensor containing such a pair of electrodes, see U.S. Pat. No. 7,083,710 B2, which is incorporated herein by reference in its entirety. Optionally, a sensor of the present invention is adapted to electrically communicate with control circuitry that smoothes operation of the sensor before the sensor has achieved standard operating conditions, such as temperature. See, for example, U.S. Pat. No. 7,177,099 B2, which is also incorporated herein by reference in its entirety.

Thus, certain embodiments of the present invention provide so-called narrow band sensors such as lambda sensors that fluctuate between lean and rich indications. Other embodiments provide broadband sensors such as lambda sensors that indicate the partial pressure of oxygen, and thereby the degree of leanness or richness of an air-fuel mixture.

Some embodiments provide more than two electrodes. For example, a sensor according to the present invention may contain a plurality of measuring electrodes. For another example, a sensor may comprise a plurality of reference electrodes. In another example, a sensor may comprise, or be adapted to electrically communicate with, a standard electrode or other device providing information useful to the operation of the sensor.

### Methods of Making

Various embodiments relate to methods of making solid oxide cells. For example, some embodiments provide a method of making an electrolyte for a solid oxide cell, comprising:

applying a first metal compound to a glass substrate;
converting at least some of the first metal compound to form a first metal oxide on the glass substrate;
applying a second metal compound to the glass substrate comprising the first metal oxide; and
converting at least some of the second metal compound to form a second metal oxide on the glass substrate comprising the first metal oxide, thereby forming the electrolyte; wherein the electrolyte has an ionic conductivity greater than the bulk ionic conductivity of the first metal oxide and of the second metal oxide.

Another embodiment provides a method further comprising: applying additional first metal compound to a glass substrate comprising the first metal oxide and the second metal oxide; and

converting at least some of the additional first metal compound to form additional first metal oxide.

Still other embodiments relate to a method further comprising: applying additional second metal compound to the additional first metal oxide; and converting at least some of the additional second metal compound to form additional second metal oxide.

Still other embodiments involve a method of wherein the first metal oxide comprises strontium titanate, and the second metal oxide comprises yttria-stabilized zirconia.

Additional embodiments relate to a method wherein the first metal oxide and the second metal oxide form at least one interface adapted to allow ionic conductivity along the at least one interface.

Yet other embodiments involve a method further comprising: exposing both the first metal oxide and the second metal oxide to form a first exposure; exposing both the first metal oxide and the second metal oxide at a distance from the first exposure to form a second exposure;

contacting both the first metal oxide and the second metal oxide at the first exposure with an electrode material to form a first electrode at the first exposure;
contacting both the first metal oxide and the second metal oxide at the second exposure with an electrode material to form a second electrode at the second exposure; wherein the first electrode and the second electrode are electrically isolated from each other by the electrolyte, and are in ionic communication with each other via the electrolyte.

An exposure, in some cases, is any etching, removal, or technique for blocking the formation of electrolyte. For example, a diamond scribe can carve into the layers of electrolyte, thereby exposing the interface between layers of metal oxide material. An electrode formed in the exposure is then in contact with the interfaces between the metal oxide materials, affording ionic communication with the interface in certain embodiments.

Any suitable method can be used to perform the exposing. For example, the exposing comprises slicing, etching, or carving the electrolyte, in some embodiments. In other embodiments, the exposing comprises cleaving the glass substrate.

Sometimes, an electrode-electrolyte transition element is formed in the exposure in the layered electrolyte. Thus, other embodiments of the present invention provide a method comprising:

exposing both the first metal oxide and the second metal oxide to form a first exposure; exposing both the first metal oxide and the second metal oxide at a distance from the first exposure to form a second exposure;
contacting both the first metal oxide and the second metal oxide at the first exposure with at least one electrode-electrolyte transition element material to form a first electrode-electrolyte transition element at the first exposure;
contacting both the first metal oxide and the second metal oxide at the second exposure with at least one electrode-electrolyte transition element material to form a second electrode-electrolyte transition element at the second exposure;
optionally partially or fully reducing the first electrode-electrolyte transition element, the second electrode-electrolyte transition element, or both, to create at least one catalytic site;
contacting the first electrode-electrolyte transition element with an electrode material to form a first electrode at the first electrode-electrolyte transition element; and
contacting the second electrode-electrolyte transition element with an electrode material to form a second electrode at the second electrode-electrolyte transition element;
wherein the first electrode and the second electrode are electrically isolated from each other by the electrolyte, and are in ionic communication with each other via the electrolyte.

### DETAILED DESCRIPTION OF THE DRAWINGS

FIG. 1 shows one embodiment employing two mechanisms by which oxygen ions diffuse through the electrolyte from the cathode to the anode when the solid oxide cell is operated as a fuel cell. In this embodiment, the cathode (110) and the anode (120) are formed on a surface of the electrolyte (145) and at a distance from each other. Optionally, one or both of the cathode (110) and the anode (120) employ an electrode-electrolyte transition element (not shown). The cathode (110) is exposed to oxygen, optionally at a pressure greater than atmospheric, and oxygen is reduced to oxygen ions (O²⁻). The oxygen ions are conducted from the cathode (110) vertically into the electrolyte, which can be described as “bulk diffusion” (160) into the electrolyte (145). Upon reaching the interfaces (130) between layers of the electrolyte (145), the oxygen ions are then conducted horizontally, which can be described as “interfacial diffusion” (170) along the interfaces (130). In the vicinity of the anode (120), the oxygen ions are conducted vertically toward the anode (120), which can be described as “bulk diffusion” (165) toward the anode (120). At the anode (120), hydrogen gas, optionally at a pressure greater than atmospheric, is oxidized and water (H₂O) is formed. An external circuit (not shown) electrically connects the cathode (110) and the anode (120).

FIG. 2 shows a further embodiment wherein the electrodes more directly contact the interfaces in the electrolyte. Here, similar to the embodiment shown in FIG. 1, vertical arrows indicate opportunities for oxygen ions (O²⁻) to diffuse through bulk material, and horizontal arrows indicate opportunities for oxygen ions to diffuse along the interfaces. In this embodiment, the cathode (210) and the anode (220) are formed in a manner that penetrates several of the layers of the electrolyte (245) and provides direct contact between the interfaces (230) of the electrolyte (245) and the cathode (210) and anode (220). Optionally, one or both of the cathode (210) and the anode (220) employ an electrode-electrolyte transition element (not shown). The cathode (210) is exposed to oxygen, optionally at a pressure greater than atmospheric, and oxygen is reduced to oxygen ions (O²⁻). The oxygen ions are conducted from the cathode (210) vertically into the electrolyte, which can be described as “bulk diffusion” (260) into the electrolyte (245). Upon reaching the interfaces (230) between layers of the electrolyte (245), either through bulk diffusion (260) or through direct contact between the cathode (210) and the interfaces (230), the oxygen ions are then conducted horizontally, which can be described as “interfacial diffusion” (270) along the interfaces (230). At the anode (220), oxygen ions can pass directly from the interfaces (230) into the anode (220). Or, the oxygen ions are conducted vertically toward the anode (120), which can be described as “bulk diffusion” (265) toward the anode (220). At the anode (220), hydrogen gas, optionally at a pressure greater than atmospheric, is oxidized and water (H₂O) is formed. An external circuit (not shown) electrically connects the cathode (210) and the anode (220).

FIGS. 3 and 4 shows another embodiment in which several solid oxide cells are stacked together and operated in fuel cell mode. FIG. 3 shows the entire module (300), and FIG. 4 shows the detail of a portion of the module (300). In module (300), air is passed through oxidant channels (350) to contact cathodes (310), and hydrogen gas is passed through fuel channels (360) in the module (330) to contact anodes (320). Spacers (340) such as high temperature-stable silicone rubber spacers separate and stabilize substrates (330) containing cells, and it can be seen that cells appear on two sides of each planar substrate (330). In this embodiment, substrates (330) are coated on the top planar surface and the bottom planar surface with electrolyte (not shown). Cathodes (310) have been formed on one edge of each substrate (330), on both the top and bottom planar surfaces and extending over the electrolyte (not shown). On the opposite edge of the substrates (330), anodes (320) have been formed on both the top and bottom planar surfaces of the substrates (330), and the anodes (320) also extend some distance over the electrolyte (not shown). A conductive high temperature epoxy (314) contacts the cathodes (310) and forms a barrier; together with the spacers (340), oxidant channels (350) are formed thereby. The epoxy (314) also acts as an electrical contact for the cathodes (310), and conducts electricity to a negative current conduit (312). On the anode (320) side of module (300), another barrier is formed of the same conductive high temperature epoxy (324), which acts as an electrical contact between the anodes (320) and a positive current conduit (322). The anodes (320), spacers (340), and the epoxy (324) form fuel channels (360) for hydrogen gas to reach the anodes (320). Oxidant channels (350) and fuel channels (360) are isolated from each other by the spacers (340) and the electrolyte (not shown) deposited on the substrates (330). Water, such as in the form of steam, develops over the anodes (320) and is carried away by the flow of hydrogen. Such water can be condensed out of the hydrogen stream, which can be recirculated over the anodes (320). Module (300) also employs a top (302) and a base (304) to provide structural strength, electrical insulation, and additional control for the air and hydrogen gas flowing through the module (300). An external circuit (not shown) connects negative current conduit (312) and positive current conduit (322) to complete the circuit.

FIGS. 5-7 show a further embodiment having a cell formed on a rectangular substrate (430) and stacked to form a “cross-shaped” module (400) (see FIG. 7). Electrolyte (not shown) covers some or all of the planar surfaces of the substrate (430), and the substrate (430) can have a cell on one planar surface, and optionally another cell on the opposite planar surface. Each substrate (430) has a cathode (410) and an anode (420) formed thereon, which are physically separated yet in ionic communication by an electrolyte (not shown). FIG. 5 shows a module (400) while looking edge on to a cathode (410) (see upper left). FIG. 6 shows a module while looking edge on to an anode (420) (see upper right). The view in the lower right (callout of FIG. 6) shows the substrates (430) that support and separate the cells, and those substrates (430) can be sealed with a ceramic or solder glass powder sealant (416). By alternately stacking substrates (430), space for air to pass over the cathodes (410) and hydrogen gas to pass over the anodes (420) is provided. An external circuit (not shown) electrically connects the cathodes (410) and the anodes (420).

FIG. 8 shows yet another embodiment comprising a number of cross-shaped modules arranged into a module assembly (500). Cross-shaped modules (400) of FIGS. 4-7 can be discerned in FIG. 8 by identifying the electrolyte (545) that separates cathodes (510) from anodes (520). Each cathode (510) has been formed on a substrate (not labeled) partly or completely covered with electrolyte (545), upon which an anode (520) has also been formed. The cathodes (510) are in ionic communication with the anodes (520) via the electrolyte (545). Oxidant channels (550) introduce air into the module assembly (500) so that air flow over cathodes (510), which air is then collected in air collection tubes (555). Fuel channels (560) allow hydrogen gas to flow over anodes (520), and then the hydrogen and water vapor evolved from cell operation is collected in hydrogen collection tubes (565). Separation walls (505) separate air from hydrogen-containing fluid. Cathodes (510) electrically connect to negative electrical conduits (512), and anodes (520) electrically connect to positive electrical conduits (522). Optionally, hydrogen-containing gas containing water vapor is reconditioned such as by drying the hydrogen-containing gas, and recirculating over the proper electrodes. Positive electrical conduits (522) and negative electrical conduits (512) are electrically connected by an external electrical circuit (not shown).

FIG. 9 shows another embodiment wherein underlying layers of yttria-stabilized zirconia (640) are exposed to the cathode (610) and the anode (620) in a solid oxide cell operated as a fuel cell. This embodiment has an electrolyte comprising alternating layers of yttria-stabilized zirconia (640) and strontium titanate (650) having an interface (630) between each layer. The regions (632) where the cathode (610) contacts the interfaces (630) is relatively small, and similarly, the regions (634) where the anode (620) contacts the interfaces (630) also is relatively small. Accordingly, this embodiment takes advantage of the relatively broad cathode-electrolyte contact regions (636) where the cathode (610) contacts the several layers of yttria-stabilized zirconia (640), and the relatively broad anode-electrolyte contact region (638) where the anode (620) contacts the several layers of yttria-stabilized zirconia (640). In the cathode-electrolyte contact regions (636), oxygen ions (not shown) undergo bulk ionic conduction (arrows pointing down, labeled 660) through the yttria-stabilized zirconia (640) to reach the interfaces (630). Along the interfaces (630), the oxygen ions undergo interfacial ionic conduction (horizontal arrows, labeled 670). In the anode-electrolyte contact regions (638), oxygen ions experience bulk ionic conduction (665) toward the anode (620). In the regions labeled (632) and (634), it is also possible that oxygen ions enter and leave the electrolyte via interfacial ionic conductivity (670) without experiencing bulk ionic conductivity (660, 665).

The exposure of underlying layers of yttria-stabilized zirconia can be accomplished according to any suitable method. For example, all six layers of electrolyte (640, 650) can be formed, and then selectively etched, before applying or forming the cathode (610) and anode (620) thereon. Or, initial layers of the electrolyte (640, 650) can be formed, and masks can be used to prevent the formation of electrolyte (640, 650) that completely covers the initial layers. Then the mask is removed, exposing the initial layers of the electrolyte (640, 650) to the cathode (610) and anode (620) formed thereon. For greater visual clarity, each and every one of items 630, 632, 634, 636, 638, 660, 665, and 670 have not been labeled.

The embodiment shown in FIG. 9 enjoys at least three unexpected advantages. First, oxygen ions enter and leave the yttria-stabilized zirconia across broad regions (636, 638). Second, the oxygen ions diffuse through relatively thin, single layers of metal oxide electrolyte (640) to reach the interfaces (630) or the anode (620). As explained elsewhere, a single layer of yttria-stabilized zirconia can be as thin as 2 nm. Third, oxygen ions undergo rapid diffusion (670) along the interfaces (630), and this embodiment employs multiple interfaces (630) for a greater ionic flux. Multiple interfaces means a greater current density is possible, compared to, for example, an electrolyte having but a single interface, or an electrolyte that effectively employs only a single interface due to the unexpected barrier effect of an electrolyte material exhibiting poor bulk ionic conductivity.

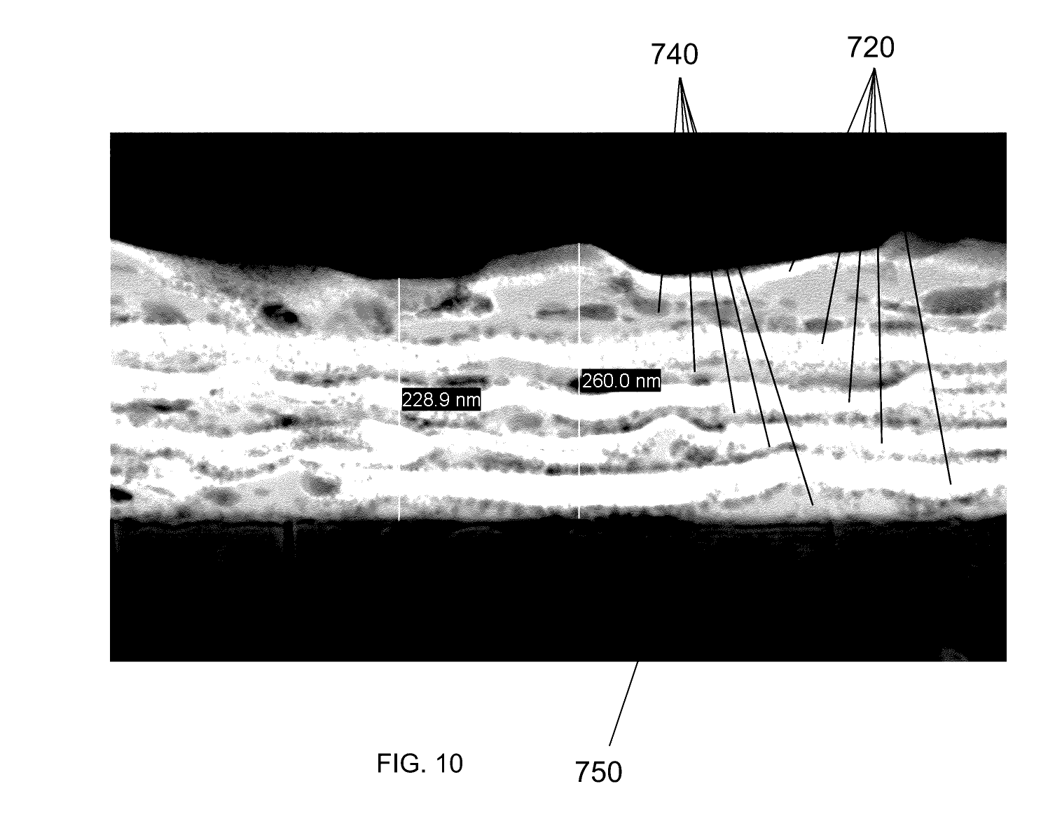

FIG. 10 shows an additional embodiment viewed in cross section by Scanning Transmission Electron Microscopy (“STEM”) showing alternating layers of YSZ (720) and STO (740) on glass (750). The identity of the layers were determined by Energy Dispersive X-Ray (“EDX”) Elemental Analysis (not shown). As explained elsewhere herein, a metal compound composition containing strontium and titanium compounds was deposited on the glass substrate (750) and heated, thereby forming strontium titanate (740). Then, another metal compound composition containing yttrium and zirconium compounds was deposition on the strontium titanate (740) and heated to form yttria-stabilized zirconia (720). Alternating layers were formed in this fashion. STEM sample preparation was performed with Hitachi NB5000 Dual Focus Ion Beam. A layer of carbon having dimensions 12×10 microns, followed by two layers of tungsten were deposited on the sample surface. A Hitachi HD2000 Scanning Transmission Electron Microscope (STEM), and Hitachi H9500 High Resolution Transmission Electron Microscopy (TEM) were used for imaging, and Oxford Energy Dispersive X-ray (EDX) Spectroscopy was used to determine chemical composition. Magnification in FIG. 10 is approximately 150,000.

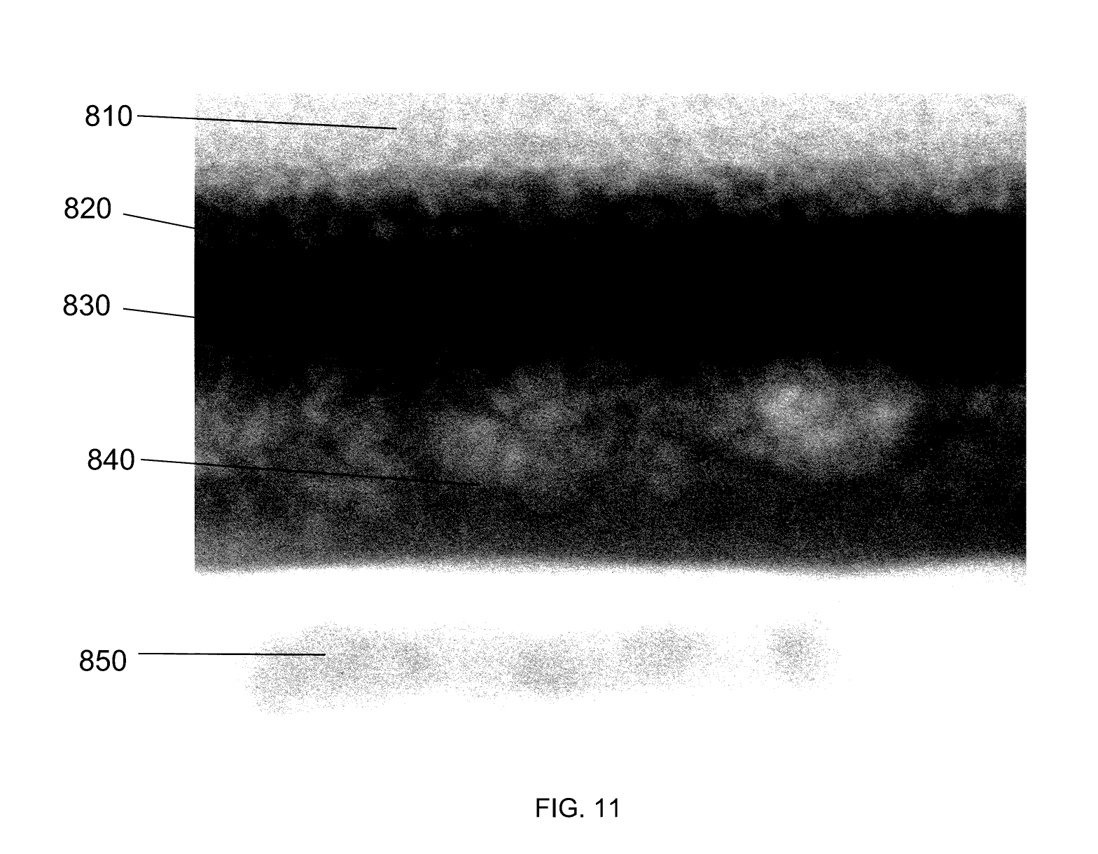

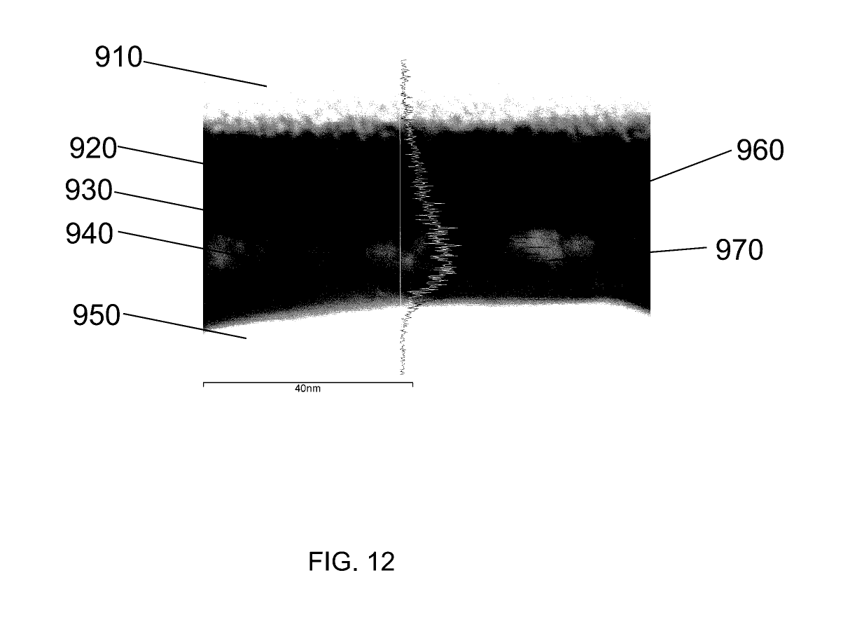

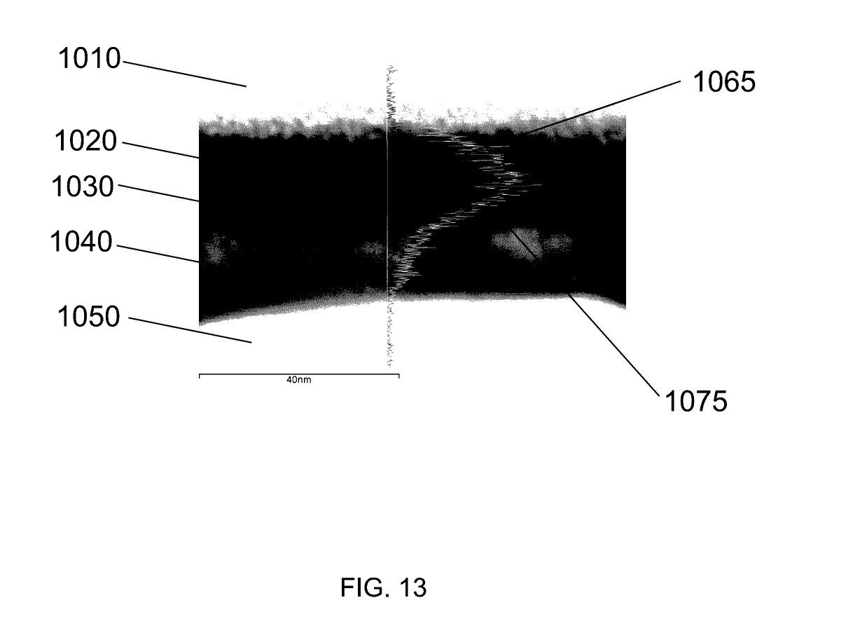

FIG. 11 shows yet another embodiment viewed in cross section by STEM comprising a layer of yttria-stabilized zirconia (820) over a layer of strontium titanate (840). As described elsewhere, the strontium titanate (840) was formed on glass (850) by depositing and then heating a suitable metal compound composition. Then, the yttria-stabilized zirconia (820) was formed on the strontium titanate (840) in similar fashion. The interface (830) between the strontium titanate (840) and yttria-stabilized zirconia (820) can be discerned as the transition from darker YSZ (820) to lighter STO (840). Magnification is approximately 1.3 million. Scale is shown in FIG. 12 and FIG. 13. A layer of carbon (810) has been added to protect the sample.

FIG. 12 shows the same embodiment shown in FIG. 11 with EDX signals for strontium (960) and titanium (970) overlaying the STEM image, confirming the identity of the STO layer (940). Strontium titanate (740) was formed on glass (950) as described herein by depositing and heating a suitable metal compound composition on the glass (950). Then, another metal compound composition was deposited on the STO (940) and heated, thereby forming the yttria-stabilized zirconia (920). The interface (930) can be discerned between the STO (940) and YSZ (920). A layer of carbon (910) was deposited on the surface to protect the sample. The scale bar showing 40 nm suggests the STO (940) and YSZ (920) are both approximately 10-15 nm each.

FIG. 13 shows the same embodiment shown in FIG. 11 and FIG. 12 with EDX signals for yttrium (1065) and zirconium (1075) overlaying the STEM image, confirming the identity of the YSZ layer (1020). STO (1040), glass substrate (1050), interface (1030), and protective carbon (1010) can be seen in FIG. 13.

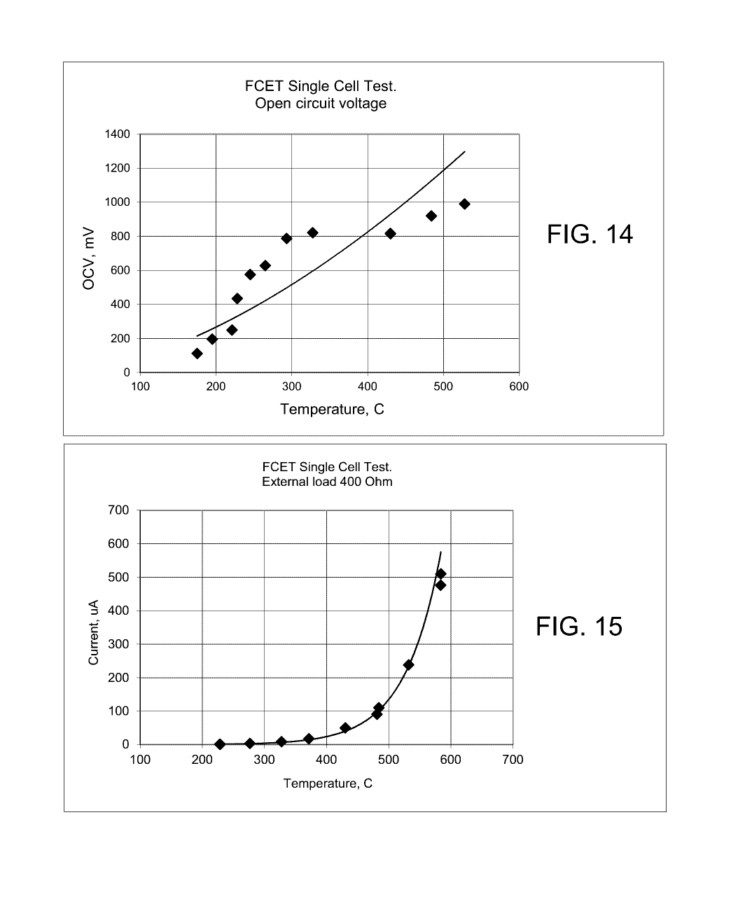

FIGS. 14-15 show the open circuit voltage (FIG. 14) and the current (FIG. 15) generated by a cell having a layer of YSZ over a layer of STO, plotted versus temperature. The cell is described in Example 4, and the measurements in Example 5.

### EXAMPLES

The following examples are presented to illustrate the claimed invention but are not to be deemed limitative thereof. Unless otherwise specified, all parts are by weight and all temperatures are in degrees Centigrade. The equipment, materials, volumes, weights, temperatures, sources of materials, manufacturers of equipment, and other parameters are offered to illustrate, but not to limit, the invention. All such parameters can be modified within the scope of the claimed invention.

### Example 1—Two Layer, One Interface Solid Oxide Electrolyte

On a standard glass microscope slide (Ted Pella, Inc.) having dimensions of 50×75 mm, baked in air for about 1 hour at 400° C. and cut to 18×18 mm, and having a thickness of 0.96 to 1.06 mm, a composition containing strontium carboxylates and titanium carboxylates having a metal concentration of about 19 g/kg was spin-coated at 300 rpm for 5 seconds, 600 rpm for 5 seconds, 1500 rpm for 5 seconds, 2000 rpm for 5 seconds, 6000 rpm for 5 seconds, and 8000 rpm for 20 seconds. Then the sample was heated to 420 to 450° C. in air and allowed to cool, thereby forming a single coating layer of strontium titanate (“STO”) on the glass. Then, a composition containing yttrium carboxylates and zirconium carboxylates having a metal concentration of about 3 g/kg was spin-coated on the STO, heated to 420 to 450° C. in air and allowed to cool, thereby forming a single coating layer of yttria-stabilized zirconia (“YSZ”) on the STO. For convenience, “coating” in these Examples will refer to an application of a material, and “layer” will refer to a given material. A “layer” contains one or more “coatings.”

### Example 2—Four Coatings, Two Layers, One Interface Solid Oxide Electrolyte

Employing the same procedures as outlined in Example 1, a layered electrolyte was prepared. A coating of STO was formed on the glass, followed by a second coating of STO. Then, two coatings of YSZ were formed over the STO, creating a single interface between STO and YSZ. This sample appears imaged in FIGS. 11, 12, and 13.

In FIG. 11, a layer of YSZ (820) is seen formed on a layer of STO (840) with an interface (830) between them. FIG. 12 confirms the identity of the STO layer (940) by EDX, showing the signals for strontium (960) and titanium (970). FIG. 13 confirms the identity of the YSZ layer (1020) by EDX, showing the signals for yttrium (1065) and zirconium (1075) overlaying the STEM image of the sample.

### Example 3—Multiple Layer Solid Oxide Electrolyte

Employing the same procedure as outlined in Example 2, multiple layers of STO and YSZ were formed on a glass substrate. A total of twelve layers of STO and YSZ were formed on this sample, with each layer containing two coatings. Accordingly, eleven STO-YSZ interfaces were formed.

FIG. 10 shows an STEM image of the cross section of this sample. At least ten layers of STO (740) and YSZ (720) are identifiable, and nine interfaces discernible. The identity of the layers was confirmed by EDX (not shown).

### Example 4—Two Layer Solid Oxide Cell

Using a procedure similar to Example 1, a two-layer electrolyte having a layer of STO on glass followed by a layer of YSZ was made on a glass slide having dimensions of 50×75×1 mm. Then, an electrode composition containing platinum (II) 2,4-pentanedionate in chloroform (Alfa Aesar), yttrium carboxylates, and zirconium caboxylates, and silver nanoparticles (2-5 μm diameter), and organic solvent (Item V006A from Heraeus) was added and heated to 450° C. in air then allowed to cool. Care was taken so that the electrode compositions did not physically touch each other. The electrode composition was again added to the sample for a second coating, and heated to 450° C. and allowed to cool. Thereby electrodes were added to the electrolyte. Silver wires (Ted Pella Inc.) were connected to the electrodes with a conductive silver paste (Ted Pella, Inc.), and the cell was ready for testing.

### Example 5—Operating Two Layer, One Interface Solid Oxide Cell

The cell assembled in Example 4 was tested at temperatures ranging from 150 to 600° C., with oxygen gas flowing to one side of the cell and hydrogen gas flowing to the other electrode. The open circuit voltage and current generated against a 400 ohm load appear in FIGS. 14-15.

### Example 6—Module

The cell of Example 4 can be stacked into a module with each cell separated by a silicone rubber spacer (McMaster, part no. R700828SP, for example having a maximum operating temperature of about 350° C.). See FIGS. 3-4, spacer (340). A conductive epoxy filled with silver particles is available under the product name Duralco 124 from Cotronics Corp. See FIGS. 3-4, epoxy (314, 324). As suggested in FIGS. 14-15, a module comprising a stack of 1000 cells of Example 4 would generate 800 mV of electrical potential at 300° C., and about half a watt of electrical power at a temperature of about 575° C. A spacer element such as glass in the configuration shown in FIGS. 3-4, spacer (340) or alternately stacking rectangular glass substrates (430) as shown in FIGS. 4-7, and sealing the cells to form oxidant channels and fuel channels with ceramic or solder glass powder sealant (416) as shown in FIGS. 4-7 would support a higher temperature.

### Example 7—Module Assembly

The module of Example 6 in the configuration of FIGS. 5-7 can be arranged into a module assembly similar to the one shown in FIG. 8.

### EMBODIMENTS

### Embodiment 1

An electrolyte for a solid oxide cell, comprising:

at least one interface between a strontium titanate material and an yttria-stabilized zirconia material adapted to allow ionic conductivity along the interface.

### Embodiment 2

An electrolyte for a solid oxide cell, comprising:

at least one region adapted to allow ionic conductivity through bulk electrolyte material; and
at least one interface between two metal oxide materials adapted to allow ionic conductivity along the interface.

### Embodiment 3

The electrolyte of embodiment 2, wherein the at least one region is proximal to at least one electrode.

### Embodiment 4

The electrolyte of embodiment 2, comprising

a first region adapted to allow ionic conductivity through bulk electrolyte material,
wherein the first region is proximal to a first electrode;
a second region adapted to allow ionic conductivity through bulk electrolyte material,
wherein the second region is proximal to a second electrode;
wherein the first region is separated from the second region by the at least one interface.

### Embodiment 5

The electrolyte of embodiment 2, wherein the two metal oxide materials comprise a strontium titanate material and an yttria-stabilized zirconia material.

### Embodiment 6

An electrolyte for a solid oxide cell, comprising:

a first region proximate to a first electrode adapted to allow ionic conductivity through bulk electrolyte material;
a second region proximate to a second electrode adapted to allow ionic conductivity through bulk electrolyte material; and
at least one interface between two metal oxide materials adapted to allow ionic conductivity along the interface,
wherein the at least one interface separates the first region and the second region, and provides ionic communication between the first region and the second region.

### Embodiment 7

The electrolyte of embodiment 6, wherein

the first region is adapted to provide ionic conductivity in a first direction;
the second region is adapted to provide ionic conductivity in a second direction;
the at least one interface is adapted to provide ionic conductivity in a third direction;
wherein the first direction is substantially antiparallel to the second direction, and
the first direction and the second direction are substantially normal to the third direction.

### Embodiment 8

An electrolyte for a solid oxide cell, comprising: a plurality of interfaces between alternating layers of a strontium titanate material and an yttria-stabilized zirconia material adapted to allow ionic conductivity along the interfaces.

### Embodiment 9

The electrolyte for a solid oxide cell of embodiment 2, wherein the electrolyte has a surface area less than about 200 mm².

### Embodiment 10

The electrolyte for a solid oxide cell of embodiment 9, wherein the at least one interface between two metal oxide materials comprises an interface between a strontium titanate material and an yttria-stabilized zirconia material.

As previously stated, detailed embodiments of the present invention are disclosed herein; however, it is to be understood that the disclosed embodiments are merely exemplary of the invention that may be embodied in various forms. It will be appreciated that many modifications and other variations are within the intended scope of this invention as claimed below. Furthermore, the foregoing description of various embodiments does not necessarily imply exclusion. For example, “some” embodiments may include all or part of “other” and “further” embodiments within the scope of this invention. In addition, “a” does not mean “one and only one;” “a” can mean “one and more than one.”

We claim:

1. A module comprising a plurality of cells stacked together,
wherein each cell comprises
a substrate,
an electrolyte on the substrate, the electrolyte comprising
at least one region adapted to allow ionic conductivity through bulk electrolyte material; and
at least one interface between two metal oxide materials adapted to allow ionic conductivity along the at least one interface; and
two electrodes electrically isolated from each other and in ionic communication with each other via the at least one interface; and
a sealant sealing the cell to form an oxidant channel and a fuel channel for the cell.

2. The module of claim 1, wherein the at least one region comprises
a first region adapted to allow ionic conductivity through bulk electrolyte material,
wherein the first region is proximal to a first electrode among the two electrodes;
a second region adapted to allow ionic conductivity through bulk electrolyte material,
wherein the second region is proximal to a second electrode among the two electrodes;
wherein the first region is separated from the second region by the at least one interface.

3. The module of claim 1, wherein
the substrate is rectangular, and
the module is a cross-shaped module.

4. The module of claim 1, wherein the two electrodes comprise platinum oxide, yttria-stabilized zirconia, and silver particles.

5. The module of claim 1, comprising 1000 cells.

6. The module of claim 1, wherein the substrate is glass.

7. The module of claim 1, wherein the sealant is a ceramic powder sealant or a solder glass powder sealant.

8. The module of claim 1, wherein the sealant is an epoxy.

9. The module of claim 1, further comprising a plurality of spacer elements separating the substrates.

10. The module of claim 9, wherein the plurality of spacer elements comprises at least one silicon rubber spacer.

11. The module of claim 1, further comprising a conductive epoxy on the two electrodes.

12. The module of claim 11, wherein the conductive epoxy comprises silver particles.
